(19) United States
(12) Patent Application Publication
(10) Pub. No.: US 2021/0207432 A1
(43) Pub. Date: Jul. 8, 2021

(54) Safety Gate

(71) Applicant: Mattel, Inc., El Segundo, CA (US)

(72) Inventors: Maarten Van Huystee, Lancaster, NY (US); Noah Paul Mauer, Warsaw, NY (US); Ross Rumfola, III, Akron, NY (US)

(21) Appl. No.: 17/140,514

(22) Filed: Jan. 4, 2021

Related U.S. Application Data
(60) Provisional application No. 62/956,829, filed on Jan. 3, 2020.

(51) Int. Cl. E06B 9/04; E05C 1/00; E05C 1/10; E05B 47/00; E05B 41/00

(52) U.S. Cl. CPC E06B 9/04; E05C 1/004; E06B 2009/002; E05B 47/0012; E05B 41/00; E05C 1/10

(57) ABSTRACT

An improved safety gate includes a door pivotally disposed within a door frame, a plurality of extension frame members that are removably coupleable to the door frame, a pair of wall clamping members that are removably coupleable to the door frame and/or the extension frame members, and a remote actuator that is disposed at a remote location from the door and door frame. The door is configured to pivot between a closed position and an open position. The door includes a latching mechanism that secures the door to the closed position. In one operational method, the door may be manually unlatched/unlocked via a manual actuator located on the door so that the door may be rotated to the open position. In another operational method, the remote actuator may be activated to unlatch/unlock the door so that the door may be rotated to the open position.

### CROSS-REFERENCE TO RELATED APPLICATIONS

This application claims priority under 35 U.S.C. 119(e) to U.S. Provisional Patent Application Ser. No. 62/956,829, entitled “Safety Gate,” filed Jan. 3, 2020, the disclosure of which is incorporated herein by reference in its entirety for all purposes.

### FIELD OF THE INVENTION

The present invention relates to a safety gate. More specifically, the invention relates to a safety gate having door and two methods for unlocking the gate, where the first method is a traditional manual latch mechanism for unlocking the gate door, and the second method is a remote button/control apparatus for unlocking the gate door.

### BACKGROUND OF THE INVENTION

Safety gates, also known as baby gates, are often use to confine children to a certain area (i.e., a playroom) or prevent children from entering a dangerous area (i.e., stairwell, kitchen, etc.) for their protection and wellbeing. Safety gates are often mounted within a doorframe or other threshold. Some safety gates are equipped with a door that allows passage through the gate by opening the door, while other safety gates serve merely as a barrier without providing any passage therethrough. When the safety gates are equipped with a door, the safety gates are further equipped with a complex latching/locking mechanism that requires multiple steps to be performed in order to open the door of the safety gate. The multiple steps of the complex latching/locking mechanism serves to prevent children from being able to open the door.

These complex latching/locking mechanisms are often cumbersome for adults to operate, especially when the adult is carrying other items. These latching/locking mechanisms require at least one hand of the adult to be free, and, because of the height of the safety gate, often require the adult to bend over. Thus, traditional latching/locking mechanisms of safety gates are difficult to operate when the adult is carrying an object (e.g., an infant or toddler, laundry, boxes, etc.). In addition, some safety gates are attached to the door frame by drilling attachment mechanisms into the door frames, and securing the safety gate to the attachment mechanisms, which results in damaged doorways that need to be repaired once the safety gates are no longer required.

Therefore, there is a need for safety gates equipped with a door that allows for easy operation (i.e., locking and unlocking) of the door of the gate. In addition, there is a need for a safety gate that can be secured within a doorway or threshold without destroying or putting holes in the adjacent walls.

### SUMMARY OF THE INVENTION

The present invention disclosed herein is a safety gate, also known as a baby gate, that is used to keep children and/or pets safe within a home or other building. According to at least one embodiment of the present invention, the safety gate includes a door pivotally disposed within a door frame, a plurality of extension frame members that are removably coupleable to the door frame, a pair of wall clamping members that are removably coupleable to the door frame and/or the extension frame members, and a remote actuator that is disposed at a remote location from the door. The door is configured to pivot between a closed position, where the door is in the same vertical plane as the door frame members, the extension frame members, and/or the wall clamping members, and an open position, where the door is rotated or pivoted from the closed in plane position to a position out of plane from the vertical plane in which the extension frame members and/or the wall clamping members are disposed. The door includes a latching mechanism that secures the door to the closed position. In one operational method, the door may be unlatched/unlocked from the closed position and rotated to the open position via a manual actuator located on the door. In another operational method, the remote actuator may be activated to unlatch/unlock the door from the closed position so that the door can be rotated to the open position. The door may further be equipped with audible output device(s) and visual output device(s) that output their respective outputs based on operations of the latching mechanism, positions of the door, etc.

### BRIEF DESCRIPTION OF THE DRAWINGS

FIG. 1A illustrates a front view of an embodiment of a safety gate that provides two ways to unlock/lock the door of the safety gate of the present invention.

FIG. 1B illustrates a top view of the embodiment of the safety gate illustrated in FIG. 1A, the safety gate door being in the closed position.

FIG. 1C illustrates a top view of the embodiment of the safety gate illustrated in FIG. 1A, the safety gate door being in the open position.

FIG. 2A illustrates a top perspective view of the embodiment of the safety gate illustrated in FIG. 1A.

FIG. 2B illustrates a bottom perspective view of the embodiment of the safety gate illustrated in FIG. 1A.

FIG. 3A illustrates a top perspective view of the door frame and door of the embodiment of the safety gate illustrated in FIG. 1A.

FIG. 3B illustrates a first side view of the door frame and the door illustrated in FIG. 3A.

FIG. 3C illustrates the second side view of the door frame and the door illustrated in FIG. 3A.

FIG. 4A illustrates a front view of internal components of the top housing portion of the door of the embodiment of the safety gate illustrated in FIG. 1A.

FIG. 4B illustrates a rear view of the top housing portion of the door of the embodiment of the safety gate illustrated in FIG. 1A.

FIG. 4C illustrates a rear view of the top housing portion of the door of the embodiment of the safety gate illustrated in FIG. 1A, where the battery box cover is removed.

FIG. 4D illustrates an isolated perspective view of the front side of the latching mechanism illustrated in FIG. 4A.

FIG. 4E illustrates an isolated perspective view of the rear side of the latching mechanism illustrated in FIG. 4B.

FIG. 4F illustrates an isolated perspective view of a portion of the mechanism of the embodiment of the safety gate illustrated in FIG. 1A.

FIGS. 5A-5C illustrate various views of the remote actuator of the embodiment of the safety gate illustrated in FIG. 1A.

FIGS. 6A and 6B illustrate front and rear views of the wall mount for the remote actuator illustrated in FIGS. 5A-5C.

FIGS. 7A and 7B illustrate front and rear views of the battery box panel for the remote actuator illustrated in FIGS. 5A-5C.

FIGS. 8A and 8B illustrate front and rear views of the actuator base for the remote actuator illustrated in FIGS. 5A-5C.

FIGS. 9A and 9B illustrate front and rear views of the actuator printed circuit board (PCB) and actuator cover for the remote actuator illustrated in FIGS. 5A-5C.

FIGS. 10A and 10B illustrate front and rear views of the actuator cover disposed within the actuator housing for the remote actuator illustrated in FIGS. 5A-5C.

FIGS. 11A and 11B illustrate front and rear views of the light emitting diode (LED) cover for the remote actuator illustrated in FIGS. 5A-5C.

FIGS. 12A and 12B illustrate front and rear views of the actuator cover disposed within the actuator housing, which is disposed within the LED cover, for the remote actuator illustrated in FIGS. 5A-5C.

FIG. 13A illustrates a front view of the actuator PCB coupled to the actuator base illustrated in FIGS. 8A and 8B of the embodiment of the safety gate illustrated in FIG. 1A.

FIG. 13B illustrates a front view of the LED cover coupled to the actuator base illustrated in FIGS. 8A and 8B and partially covering the actuator PCB illustrated in FIGS. 9A and 9B of the embodiment of the safety gate illustrated in FIG. 1A.

FIG. 13C illustrates a front view of the actuator housing coupled to the LED cover illustrated in FIGS. 11A and 11B and the actuator base illustrated in FIGS. 8A and 8B, while also partially covering the actuator PCB illustrated in FIGS. 9A and 9B of the embodiment of the safety gate illustrated in FIG. 1A.

FIG. 14 illustrates a cross sectional view of the remote actuator of the embodiment of the safety gate illustrated in FIG. 1A.

FIGS. 15A-15C illustrate various positions of the remote actuator illustrated in FIGS. 5A-5C.

FIGS. 16A-16C illustrate side views (both the first side and the second side) as well as a front view of one of the extension frame members of the embodiment of the safety gate illustrated in FIG. 1A.

FIG. 17A illustrates a perspective view of the first side of a wall clamping member of the embodiment of the safety gate illustrated in FIG. 1A.

FIG. 17B illustrates a perspective view of the second side of the wall clamping member illustrated in FIG. 17A.

FIG. 17C illustrates a front view of the wall clamping member illustrated in FIG. 17A.

FIG. 18A illustrates a front view of a clamping assembly of the wall clamping member illustrated in FIG. 17A.

FIG. 18B illustrates a front perspective view of the clamping assembly illustrated in FIG. 18A with the front cover removed.

FIGS. 19A and 19B illustrate cross sectional views of the wall clamping member of FIG. 17A connected to one of the extension frame members illustrated in FIGS. 16A and 16B.

FIG. 20A and 20B illustrate a flowchart of the operations of the actuator LED, the actuator illustrated in FIGS. 5A-5C, the door illustrated in FIGS. 3A-3C, and LED's and the speaker of the embodiment of the safety gate illustrated in FIG. 1A.

FIG. 21A illustrates a schematic drawing of the electronics of the safety gate illustrated in FIG. 1A.

FIG. 21B illustrates a schematic drawing of the electronics of the remote actuator illustrated in FIGS. 5A-5C.

FIGS. 22A and 22B illustrate perspective views of a second embodiment of the remote actuator in accordance with the present invention.

FIGS. 23A and 23B illustrate perspective views of the first housing portion of the second embodiment of the remote actuator illustrated in FIGS. 22A and 22B, and in accordance with the present invention.

FIG. 24 illustrates a cross sectional view of the first housing portion illustrated in FIGS. 23A and 23B, and in accordance with the present invention.

FIGS. 25A and 25B illustrate perspective views of the first housing portion illustrated in FIGS. 23A and 23B where portions of the first housing portion are removed.

FIG. 26 illustrates a rear perspective view of the first housing portion illustrated in FIGS. 23A and 23B attached to the first half housing of the second housing portion of the second embodiment of the remote actuator illustrated in FIGS. 22A and 22B, and in accordance with the present invention.

FIG. 27A illustrates a rear perspective view of the second embodiment of the remote actuator illustrated in FIGS. 22A and 22B with the wall plate removed from the second half housing of the second housing portion.

FIG. 27B illustrates a rear perspective view of the second embodiment of the remote actuator illustrated in FIGS. 22A and 22B with the wall plate and battery cover removed from the second half housing of the second housing portion.

FIG. 28A illustrates operation of the remote actuator illustrated in FIGS. 22A and 22B to actuate the latch mechanism in the gate in accordance with the present invention.

FIG. 28B illustrates operation of the remote actuator illustrated in FIGS. 22A and 22B with the gate in the open position and in accordance with the present invention.

Like reference numerals have been used to identify like elements throughout this disclosure.

### DETAILED DESCRIPTION OF THE INVENTION

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment,” “an embodiment,” “an exemplary embodiment,” and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used with respect to embodiments of the present disclosure, are synonymous.

The present invention disclosed herein is a safety gate, also known as a baby gate, that is used for keeping children and/or pets safe within a home or other building. The safety gate includes a door pivotally disposed within a door frame, a plurality of extension frame members that are removably coupleable to the door frame, a pair of wall clamping members that are removably coupleable to the door frame and/or the extension frame members, and a remote actuator that is disposed at a remote location from the door. The door is configured to pivot between a closed position, where the door is in the same vertical plane as the door frame members, the extension frame members, and/or the wall clamping members, and an open position, where the door is rotated or pivoted from the closed in plane position to a position out of plane from the vertical plane in which the extension frame members and/or the wall clamping members are disposed. The door includes a latching mechanism that secures the door to the closed position. In one operational method, the door may be unlatched/unlocked from the closed position and rotated to the open position via a manual actuator located on the door. In another operational method, the remote actuator may be activated to unlatch/unlock the door from the closed position so that the door may be rotated to the open position. The door may further be equipped with audible output device(s) and visual output device(s) that output their respective outputs based on operations of the latching mechanism, positions of the door, etc.

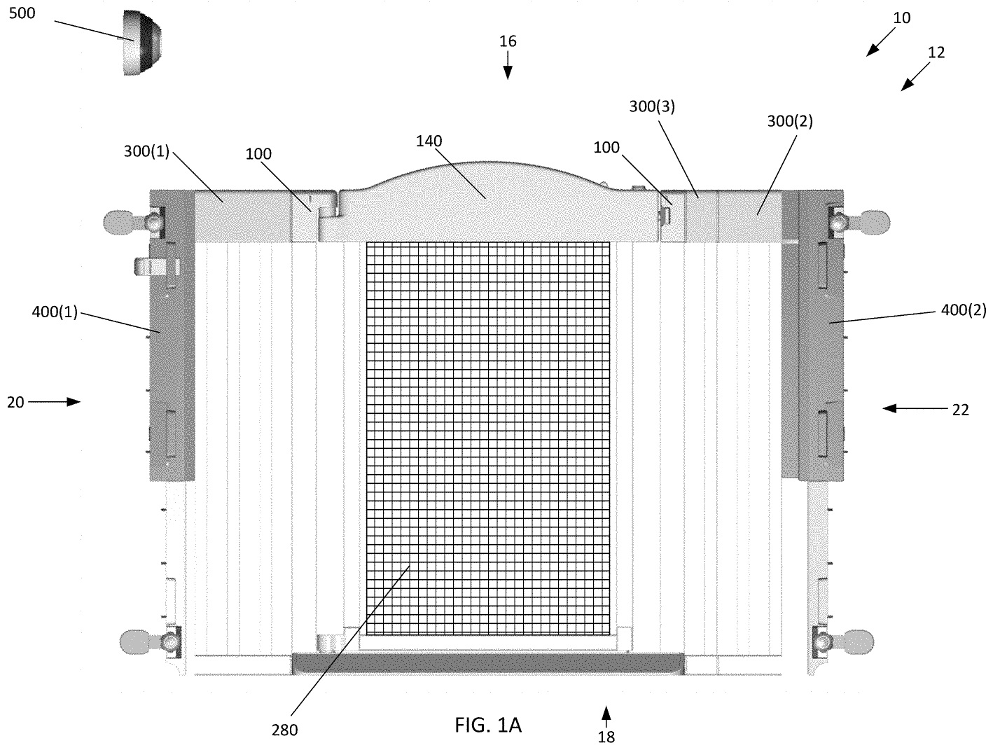

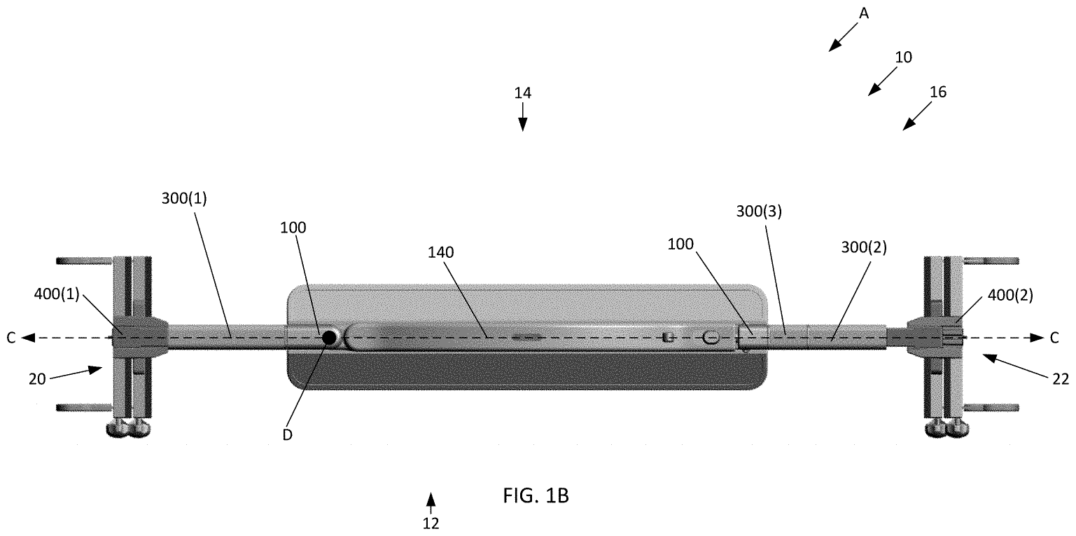

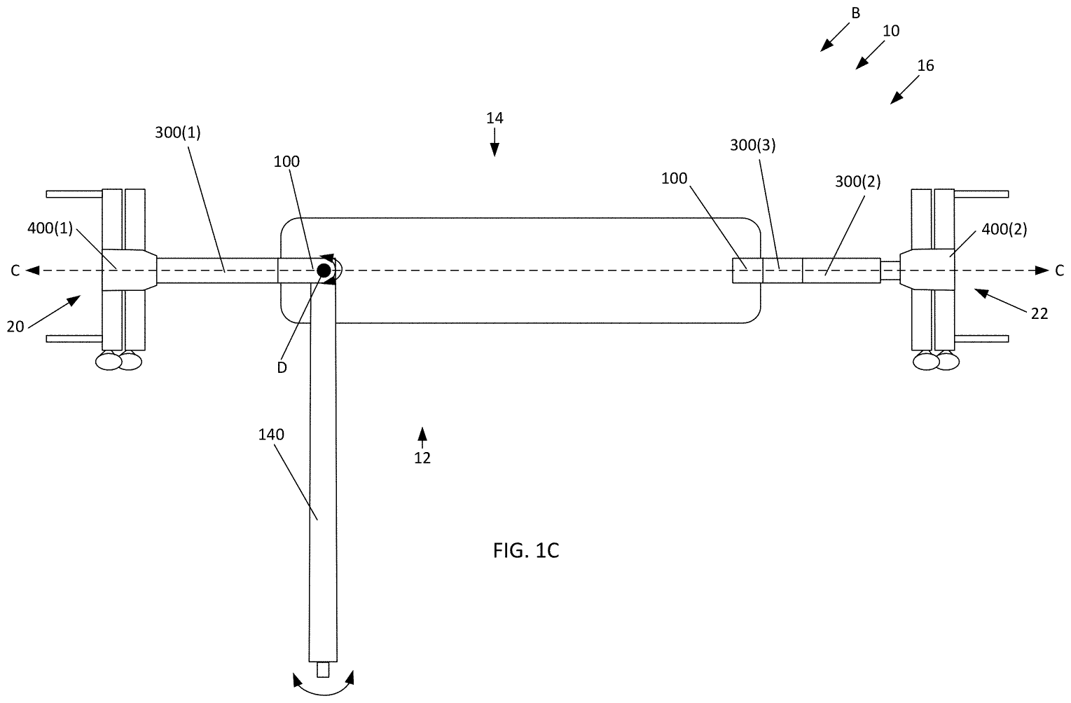

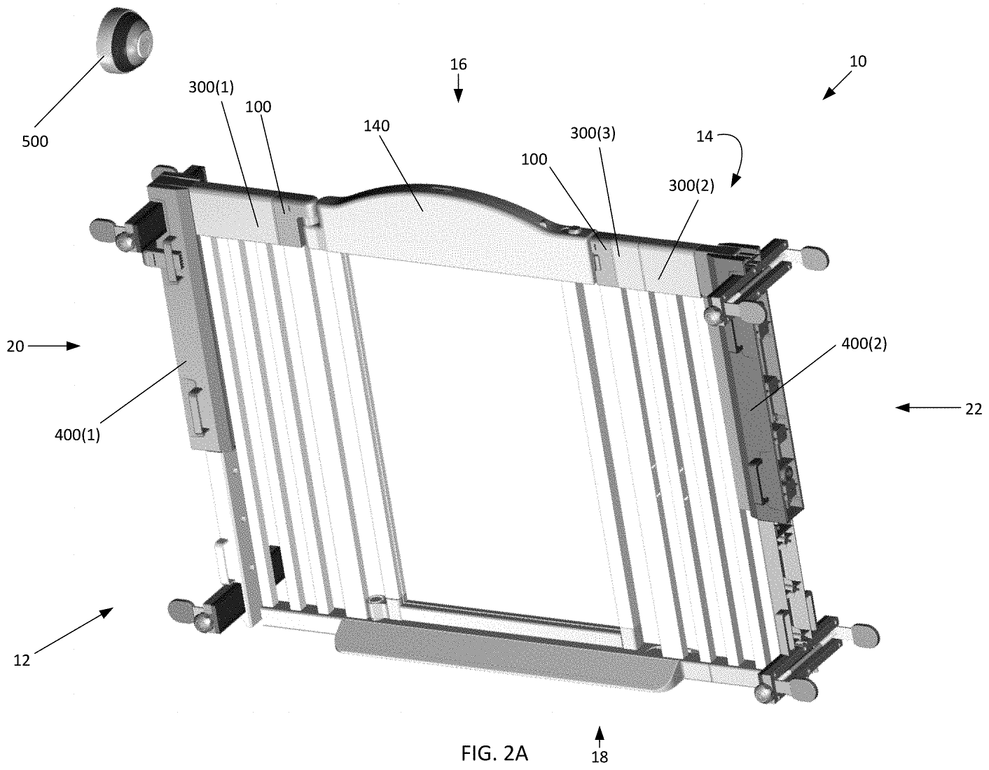

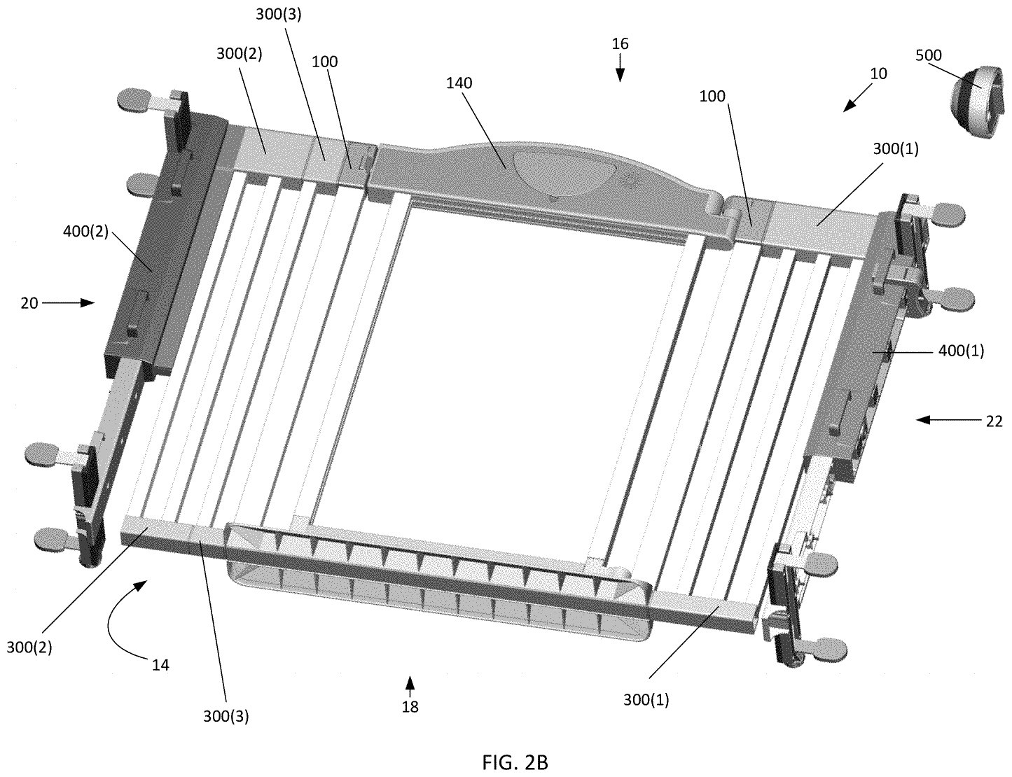

Turning to FIGS. 1A-1C, 2A, and 2B, illustrated is safety gate 10. The safety gate 10 contains a front side 12, a rear side 14 opposite the front side 12, a top side 16, and a bottom side 18 disposed opposite the top side 16. The bottom side 18 of the safety gate 10 is configured to sit upon, rest on, and/or abut a support surface. In addition, the safety gate 10 includes a first side 20, and a second side 22 disposed opposite the first side 20.

The safety gate 10 includes a door frame 100, a door or door assembly 140, a plurality of extension frame members 300(1), 300(2), 300(3), and a pair of wall clamping member 400(1), 400(2), and a remote actuator 500. Each one of these structures or components is discussed in more detail below.

As illustrated in FIGS. 1B and 1C, the door 140 is rotatable or pivotable between a closed position A (shown in FIG. 1B) and an opened position B (shown in FIG. 1C). As shown in FIGS. 1B and 1C, the extension frame members 300(1), 300(2), 300(3), the wall clamping members 400(1), 400(2), and the door frame 100 are all disposed in the same vertical plane C. As best illustrated in FIG. 1B, when the door 140 is in the closed position A, the door 140 is aligned with each of the extension frame members 300(1), 300(2), 300(3), the wall clamping members 400(1), 400(2), and the door frame 100 in the vertical plane C. As best illustrated in FIG. 1C, however, when the door 140 is repositioned to the opened position B, the door 140 is rotated about vertical axis D such that the door 140 is no longer disposed within the vertical plane C, and no longer aligned with each of the extension frame members 300(1), 300(2), 300(3), the wall clamping members 400(1), 400(2), and the door frame 100.

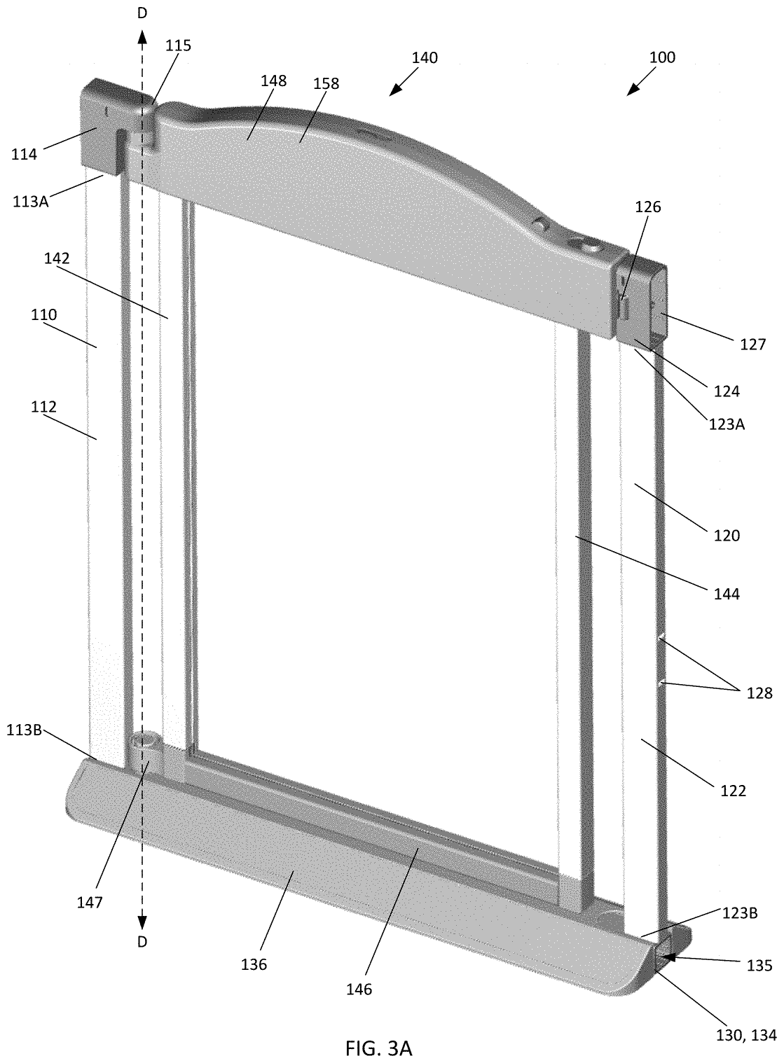

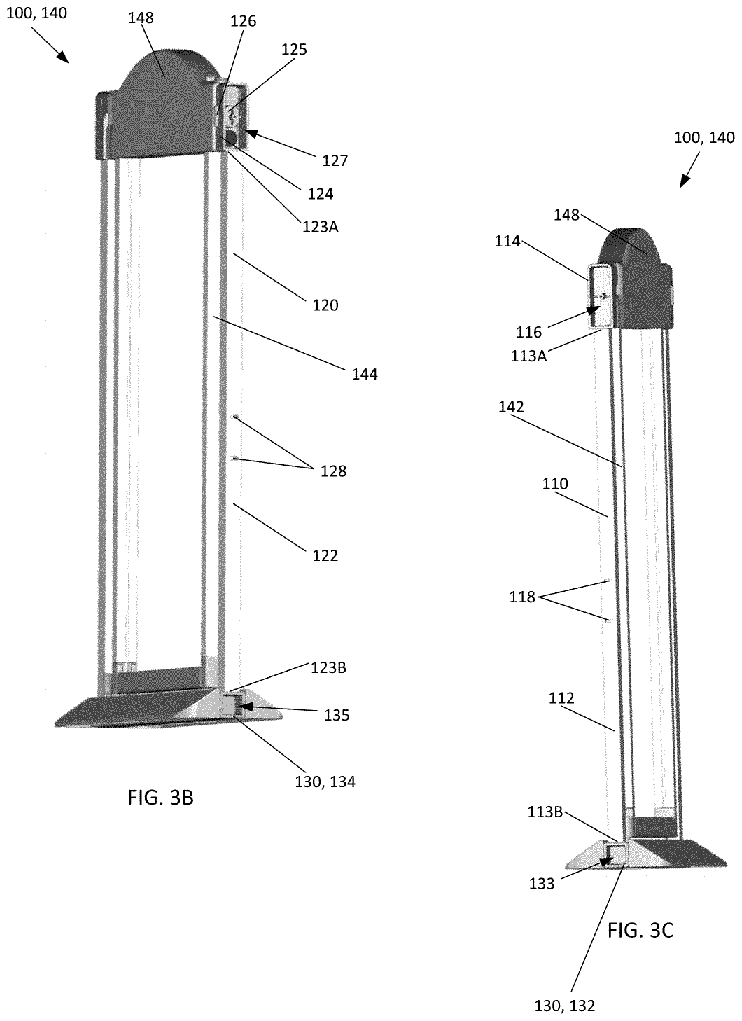

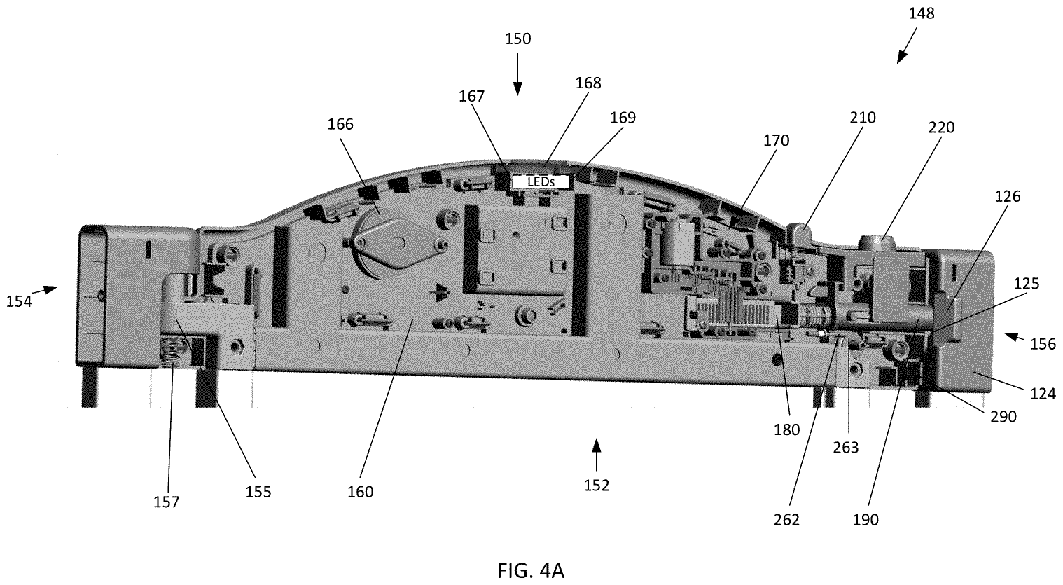

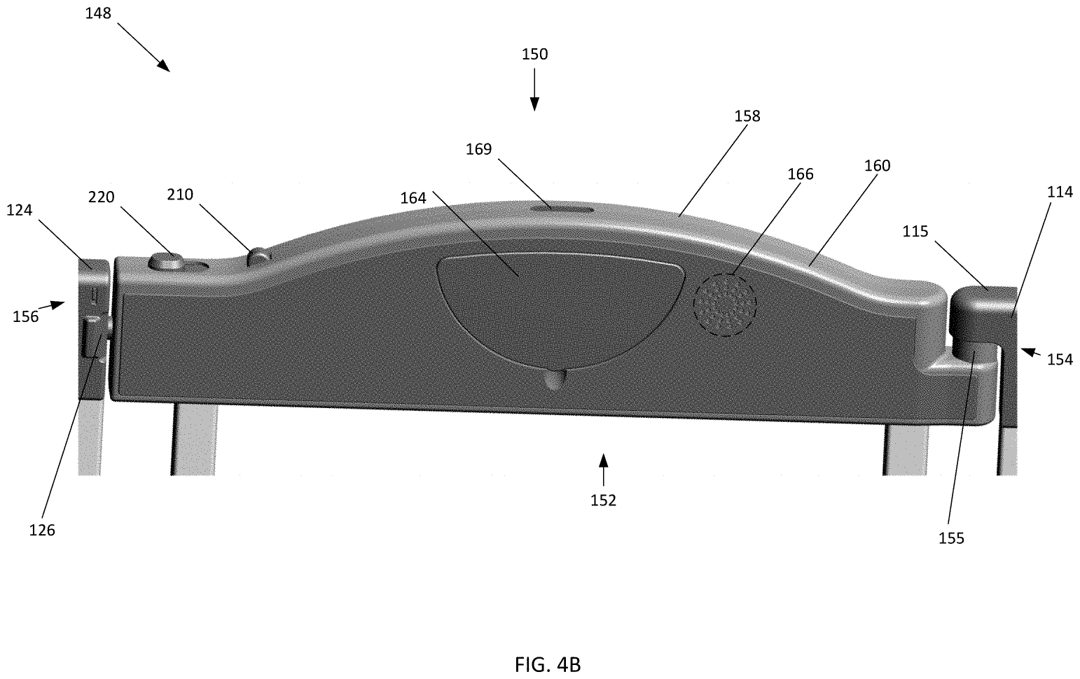

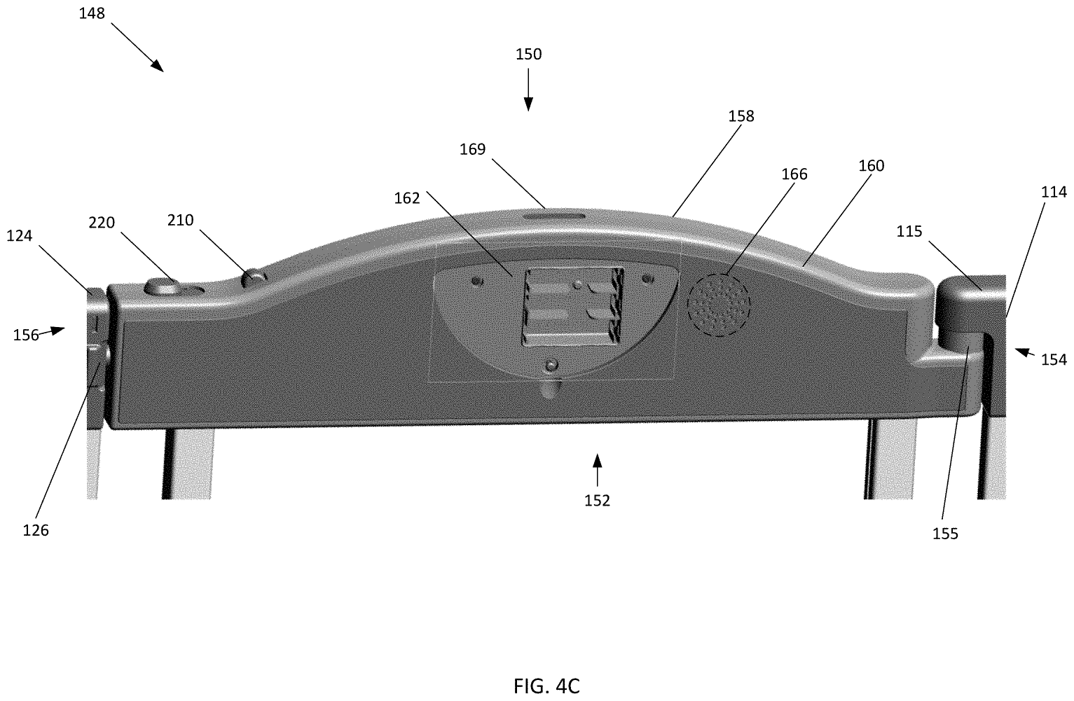

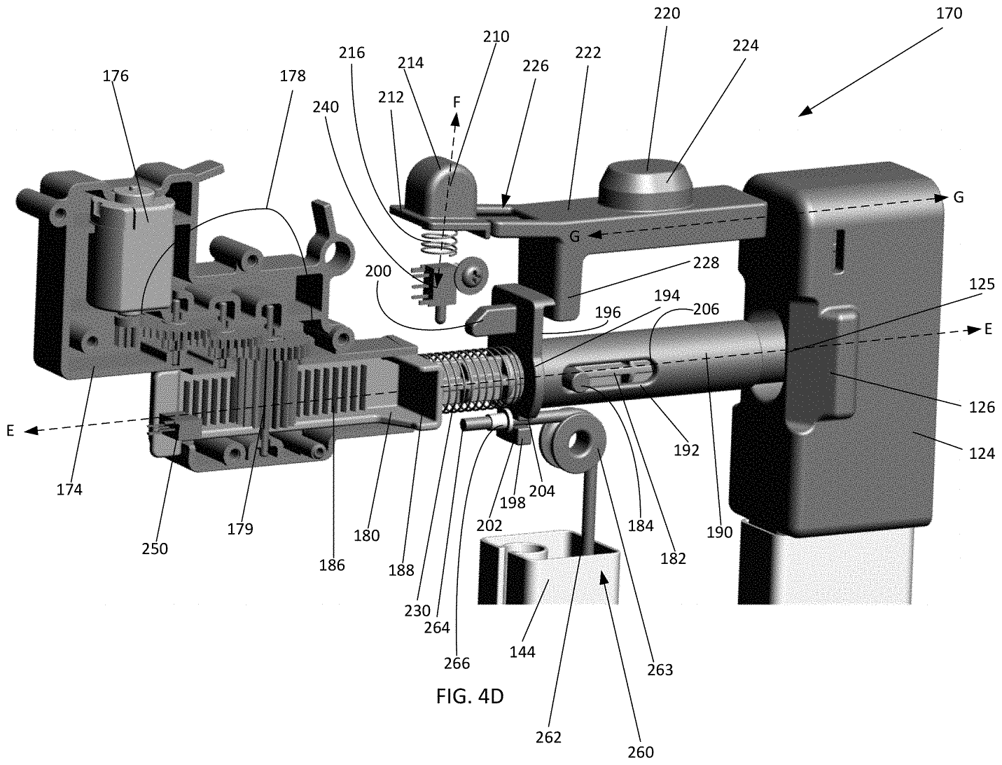

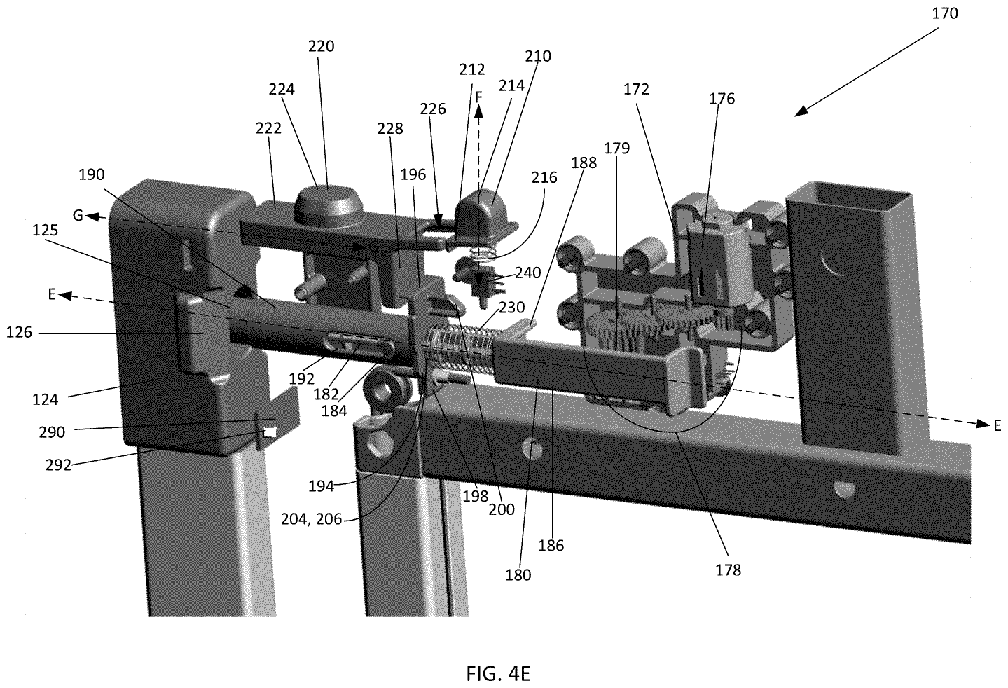

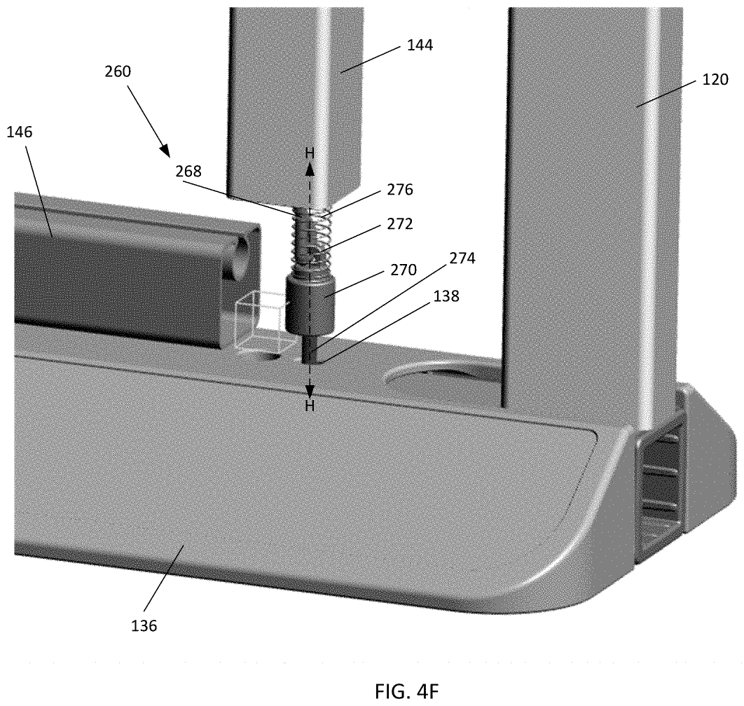

Turning to FIGS. 3A-3C, the door frame 100 of the safety gate 10 includes a first gate frame member 110, a second gate frame member 120, and a bottom frame rail 130. The first and second gate frame members 110, 120 are vertically oriented frame members, while the bottom frame rail 130 is a horizontally extending frame member. The first gate frame member 110 includes a rail 112 that has an upper end 113A and a lower end 113B. An upper housing 114 is disposed on the upper end 113A of the rail 112, where the upper housing 114 contains a hinge 115 on the door side of the upper housing 114 and a receptacle 116 disposed on the opposing side of the upper housing 124. Similarly, the second gate frame member 120 includes a rail 122 that has an upper end 123A and a lower end 123B. An upper housing 124 of the second gate frame member 120 is disposed on the upper end 123A of the rail 122, where the upper housing 124 contains a cavity 125 and a set of ramps 126 on the door side of the upper housing 124, and a receptacle 127 disposed on the opposing side of the upper housing 124. The lower end 113B of the rail 112 of the first gate frame member 110 is coupled to the first end 132 of the bottom frame rail 130, while the lower end 123B of the rail 122 of the second gate frame member 120 is coupled to the second end 134 of the bottom frame rail 130. As best illustrated in FIGS. 3B and 3C, the first end 132 of the bottom frame rail 130 has a receptacle 133 and the second end 134 of the bottom frame rail 130 also has a receptacle 135. As further illustrated, a ramped threshold 136 is disposed on, and at least partially encompassing the bottom frame rail 130 such that the bottom frame rail 130 extends centrally through the ramped threshold 136. The ramped threshold 136 also includes a locking aperture 138 (as best seen in FIG. 4D).

Continuing with FIGS. 3A-3C, the door or door assembly 140 is disposed between the first gate frame member 110, the second gate frame member 120, and the bottom frame rail 130. The door assembly 140 includes a first door rail 142, a second door rail 144, a bottom door rail 146, and a top door housing 148. The first door rail 142 is a vertically extending rail that is located proximate to the first gate frame member 110, while the second door rail 144 is a vertically extending rail that is located proximate to the second gate frame member 120 when the door is in the closed position A. The bottom door rail 146 extends between the first door rail 142 and the second door rail 144, and spans across the bottom frame rail 130 of the door frame 100 and the ramped threshold 136. The bottom door rail 146 includes a hinge 147 extending from the coupling of the first door rail 142 to the bottom door rail 146, the hinge 147 being disposed proximate to the first gate frame member 110. As further illustrated, the top door housing 148 extends across the door 140 from the first door rail 142 to the second door rail 144 on the top side of the door 140 opposite of that of the bottom door rail 146. As best illustrated in FIG. 1A, a fabric panel 280 is disposed in the door 140 between the first door rail 142, the second door rail 144, the bottom door rail 146, and the top door housing 148. The fabric panel 280 has been removed from the door 140 illustrated in FIGS. 3A-3C for illustrative purposes only.

Turning to FIGS. 3A, and 4A-4F, illustrated are various views of the top door housing 148, as well as various components of the top door housing 148. The top door housing 148 includes a front cover 158 (best illustrated in FIGS. 3A, 4B, and 4C) and a rear cover 160 that together form the top door housing 148. The top door housing 148 contains a top side 150, a bottom side 152 opposite the top side 150, a first side 154 spanning between the top and bottom sides 150, 152, and a second side 156 that is opposite the first side 154. As illustrated in FIG. 4A, which illustrates the top door housing 148 with the front cover 158 removed, the top door housing 148 includes a hinge portion 155 extending from the first side 154 of the top door housing 148. The hinge portion 155 is coupled to the hinge 115 of the upper housing 114 of the first gate frame member 110, where the hinge portion 155 and the hinge 115 function together, along with the hinge 147 of the bottom door rail 146 of the door 140, to enable the door 140 to rotate about axis D as shown in FIGS. 1B, 1C, and 3A. The hinge portion 155 of the top door housing 148 a resilient member 157 that biases the door 140 to the closed position A.

As further illustrated in FIG. 4A, disposed within the top door housing 148 is a battery compartment 162, an audible output device or speaker 166, an LED housing 167, and a latching mechanism 170. The battery compartment 162 is centrally located within the top door housing 148, while the speaker 166 is disposed more proximate to the first side 154 of the top door housing 148 than the second side 156 of the top door housing 148. The LED housing 167 is disposed proximate to the top side 150 of the top door housing 148, and centrally located between the first and second sides 154, 156. The LED housing 167 is configured to house one or more light emitting diodes (LEDs) 169 and direct light emitted by the LEDs 169 out of the translucent portion 168 of the LED housing 167. As best illustrated in FIGS. 4B and 4C, which illustrate different rear views of the top door housing 148, access to the battery compartment 162 is provided through the rear cover 160 of the top door housing 148 by a battery compartment door 164 (which is removed in FIG. 4C). The rear cover 160 also provides a series of openings proximate to the speaker 166 that allow audible outputs of the speaker 166 to be transmitted out of the top door housing 148. Moreover, the translucent portion 168 of the LED housing 167 is visible on the top side 150 of the top door housing 148 and, as previously explained, configured to transmit any visual outputs generated by the LEDs 169 disposed in the LED housing 167 out of the top door housing 148.

As further illustrated in FIGS. 4A, and 4D-4F, the latching mechanism 170 is disposed proximate to the second side 156 of the top door housing 148. The latching mechanism 170 is used to secure the door 140 in the closed position A, while also allowing the door 140 to be opened to the opened position B when desired by an operator of the safety gate 10. The latching mechanism 170 includes a first or front housing member 172 (best shown in FIG. 4E) and a second or rear housing member 174 (best shown in FIG. 4D) that house a motor 176 and a set of gears 178. The latching mechanism 170 further includes a rack member 180, a door latch 190, a first actuator 210, and a second actuator 220. The door latch 190 is substantially cylindrical structure, where one end of the door latch 190 extends out of the second side 156 of the top door housing 148 and into the cavity 125 of the upper housing 124 of the second gate frame member 120, while disposed at the opposite end of the cylindrical portion of the door latch 190 is a flange 194. The door latch 190 further includes two slots 192 that are disposed in the substantially cylindrical portion of the door latch 190 on opposing sides of one another. Furthermore, the flange 194 includes an upper end 196 and a lower end 198 disposed opposite of the upper end 196. The upper end 196 of the flange 194 contains a ramp member 200 that extends from the flange 194 toward the first side 154 of the top door housing 148. Moreover, the lower end 198 of the flange 194 contains a channel 202. In addition, the door latch 190 contains a central aperture 204 disposed in the end of the door latch 190 on which the flange 194 is disposed, and a central cavity 206 that extends through the door latch 190 (i.e., the cylindrical portion of the door latch 190 is at least partially hollow. The central cavity 206 is in fluid communication with the slots 192 and the central aperture 204. Furthermore, the door latch 190 is configured to slide laterally along axis E with respect to the top door housing 148 between a deployed or engaged position (position shown in FIGS. 4A, 4D, and 4E), where the door latch 190 extends beyond the second side 156 of the top door housing 148 and into the cavity 125 of the upper housing 124 of the second gate frame member 120, and a stowed or disengaged position, where the end of the cylinder portion of the door latch 190 does not extend from the second side 156 of the top door housing 148 as far as it does in the deployed position, and does not extend into the cavity 125 of the upper housing 124 of the second gate frame member 120 when the door is aligned with the gate frame 100 in plane C (see FIG. 1B).

Continuing with FIGS. 4A, 4D, and 4E, the first actuator 210 and the second actuator 220 are disposed above the door latch 190. The first actuator 210 includes a platform 212 with an engagement portion 214 extending upwardly from the platform 212. When the first actuator 210 is in a disengaged position, the engagement portion 214 extends out of the top door housing 148 from the top side 150 of the top door housing 148. Conversely, then the first actuator 210 is in an engaged position, the engagement portion 214 is at least partially disposed within the top door housing 148. Coupled to, or in abutment with, the bottom side of the platform 212 is a resilient member 216 that is configured to bias the first actuator 210 to the disengaged position. The first actuator 210 may be depressed by an operator of the safety gate that depressing the engagement portion 214 to cause the first actuator 210 to travel along vertical axis F and into the top door housing 148 (i.e., the engaged position). The first actuator 210 travels along vertical axis F when either being depressed into the engaged position, or biased back to the disengaged position by the resilient member 216.

The second actuator 220 is disposed proximate to the first actuator 210, and includes a platform portion 222 that may be in abutment with the platform 212 of the first actuator 210. The second actuator 220 may further include an engagement portion 224 disposed on the platform portion 222 that extends upwardly from the platform portion 222 beyond the top side 150 of the top door housing 148. The end of the platform portion 222 of the second actuator 220 that is disposed proximate to the first actuator 210 includes a channel 226. As illustrated, the channel 226 may have a width that is equivalent to, or slightly larger than, the engagement portion 214 of the first actuator 210. The second actuator 220 may further include a lower extension member 228 that extends downwardly from the platform portion 222 and may be in engagement with the upper end 196 of the flange 194 of the door latch 190. The second actuator 220 may be configured to slide laterally along axis G (i.e., travel along the length of the top door housing 148 between the first side 154 and the second side 156).

As previously explained, the latch mechanism 170 also includes a motor 176 and a set of gears 178 that are disposed between a first or front housing member 172 (best shown in FIG. 4E) and a second or rear housing member 174 (best shown in FIG. 4D). The last gear 179 of the set of gears 178 is a pinion gear 179 that is configured to interact with the rack member 180.

As best illustrated in FIG. 4D, the rack member 180 of the latch mechanism 170 includes two portions: a cylinder portion 182 and a geared portion 186. The cylinder portion 182 is disposed more proximate to the second side 156 of the top door housing 148 than the geared portion 186. The cylinder portion 182 is cylindrical in shape and is at least partially disposed within the central cavity 206 of the door latch 190 such that the rack member 180 at least partially slides laterally within the top door housing 148 and within the central cavity 206 of the door latch 190. As illustrated in FIGS. 4D and 4E, the cylinder portion 182 of the rack member 180 further includes a pin 184 that extends transversely through the cylinder portion 182 at a location between the ends of the cylinder portion 182. Moreover, the pin 184 extends into the slots 192 of the door latch 190, such that the pin 184 and slots 192 dictate the length along which the rack member 180 slides with respect to the door latch 190, or vice versa. The geared portion 186 of the rack member 180 is substantially rectangular in shape, and includes a set of gear teeth. Furthermore, the geared portion 186 of the rack member 180 is at least partially and slidably disposed between the first housing member 172 and the rear housing member 174. The rack member 180 is aligned with the pinion gear 179 such that the gear teeth of the pinion gear 179 are intermeshed with the gear teeth of the geared portion 186 of the rack member 180. Disposed between the geared portion 186 and the cylinder portion 182 of the rack member 180 is an intermediate flange 188. A resilient member 230 may be disposed around the cylinder portion between the intermediate flange 188 of the rack member 180 and the flange 194 of the door latch 190. The rack member 180 may be configured to slide laterally along axis E with respect to the top door housing 148 and into, and out of, the central cavity 206 of the door latch 190. The resilient member 230 biases the door latch 190 and the rack member 180 to the position shown in FIGS. 4D and 4E, where the pin 184 of the rack member 180 is disposed in the slots 192 proximate to the flange 194 of the door latch 190.

The latch mechanism 170 further includes a first switch 240 disposed proximate to the first actuator 210 and aligned laterally with the ramp member 200 of the door latch 190. When the door latch 190 is in the stowed or disengaged position, the ramp member 200 may contact a portion of the first switch 240 to indicates that the door latch 190 is in the stowed or disengaged position. Thus, the first switch 240 may indicate to the control assembly/PCB 290 of the safety gate 10 (located within top door housing 148 proximate to the second side 156 of the top door housing 148) the position of the door latch 190. The latch mechanism 170 may further include a second switch 250 disposed with the first housing member 172 proximate to the geared portion 186 of the rack member 180, the set of gears 178, and the motor 176. The second switch 250 may be used to indicate to the control assembly 290 of the safety gate 10 the position of the rack member 180 and or the rotational position of the set of gears 178.

As further illustrated in FIGS. 4D, 4E, and 4F, the latch mechanism 170 may also include a secondary latch 260, where the secondary latch 260 contains an elongated member 262 that extends from within the top door housing 148 downwardly through the second door rail 144 proximate to the coupling of the second door rail 144 to the bottom door rail 146. The elongate member 262 may be a flexible cord (e.g., constructed from nylon or any other suitable material). The elongate member 262 has a first end 264 disposed within the top door housing 148 (see FIG. 4D) and an opposite second end 268 (see FIG. 4E) disposed proximate to the bottom door rail 146 and the bottom frame rail 130. The first end 264 of the elongate member 262 may be routed at least partially around a roller 263 disposed within the top door housing 148, where the first end 264 is disposed/inserted through the channel 202 of the lower end 198 of the flange 194 of the door latch 190. A ferrule 266 may be coupled to the first end 264 of the elongate member 262 to secure the first end 264 to the flange 194 of the door latch 190. As previously explained, the elongate member 262 extends through the second door rail 144 such that the second end 268 of the elongate member 262 is disposed proximate to the bottom frame rail 130 and the bottom door rail 146. The second end 268 of the elongate member 262 is coupled to a cylindrical housing 270 by being threaded through an opening or looped portion 272 of the cylindrical housing 270. Extending downwardly from the cylindrical housing 270 is a lower shaft 274 that may be configured to slide freely between the extended position illustrated in FIG. 4F, and a retracted position, where the lower shaft 274 is disposed primarily within the cylindrical housing 270. The lower shaft 274 may be configured to slide freely between positions, but gravity may retain the lower shaft 274 in the extended position when an upward force is not applied or imparted onto the lower shaft 274. When the door 140 is in the closed position A, and the lower shaft 274 is in the extended position, the lower shaft 274 extends into locking aperture 138. Furthermore, a resilient member 276 is disposed around the opening or looped portion 272 and at least partially disposed around a portion of the elongate member 262. The cylindrical housing 270 may be configured to slide upward and downward along vertical axis H, which is aligned with the second door rail 144, between a lowered position (shown in FIG. 4F) and an upper position (which, as explained in further detail below, is an unlatched position). The resilient member 276 biases the cylindrical housing 270 to the lowered position.

The latch mechanism 170 operates in two manners, a manual operation and a remotely actuated operation, to disengage the door latch 190 from the cavity 125 of the upper housing 124 of the second gate frame member 120 and disengage the lower shaft 274 from the locking aperture 138 of the bottom frame rail 130. In a manual operation, a user depresses the first actuator 210 and then, while the first actuator 210 is depressed, slides the second actuator 220 towards the first actuator 210 along the length of the top door housing 148 and away from the second side 156 of the top door housing 148 (along axis G). By depressing the first actuator 210, the platform 212 is repositioned to be lower than the platform portion 222 of the second actuator 220, and the platform portion 222 of the second actuator 220 can then slide over the platform 212 of the first actuator 210 such that the channel 226 of the second actuator 220 at least partially encompasses the engagement portion 214 of the first actuator 210. When the second actuator 220 is slid over the first actuator 210, the lower extension member 228 of the second actuator 220 engages the upper end 196 of the flange 194 to slide the door latch 190 simultaneously along axis E toward the intermediate flange 188 of the rack member 180. When manually operating the latch mechanism 170, the rack member 180, the set of gears 178, and the motor 176 do not move or operate. Thus, as the door latch 190 is slid towards the intermediate flange 188 of the rack member 180, the resilient member 230 is compressed and the cylinder portion 182 of the rack member 180 is inserted further into the central cavity 206 of the door latch 190. Furthermore, the ramp member 200 of the door latch 190 contacts the first switch 240 when the second actuator 220 and the door latch 190 are slid along the top door housing 148. Once the second actuator 220 has been fully repositioned laterally along axis G, which causes the door latch 190 to be repositioned laterally along axis E, the door latch 190 may be disposed in the stowed position where the door latch 190 may no longer be disposed within the cavity 125 of the upper housing 124 of the second gate frame member 120. Moreover, as the door latch 190 slides along axis E, the elongate member 262 of the secondary latch 260 is pulled by the lower end 198 of the flange 194 of the door latch 190. In other words, the first end 264 of the elongate member 262 is pulled such that the elongate member 262 is at least partially rolled around the roller 263 and the second end 268 of the elongate member 262 and the cylindrical housing 270 is pulled upwardly along the second door rail 144 to lift the lower shaft 274 out of the locking aperture 138. With the door latch 190 no longer extending into the cavity 125 of the upper housing 124 of the second gate frame member 120 and the lower shaft 274 no longer extending into the locking aperture 138 of the bottom frame rail 130, the door 140 is free to be rotated about axis D to reposition the door from the closed position A to the opened position B.

As soon as the operator releases the engagement portion 224 of the second actuator 220, the resilient member 230 repositions the door latch 190 along axis E by biasing the door latch 190 to the deployed position. This further causes the second actuator 220 to be repositioned along axis G to the disengaged position, which releases the first actuator 210 to be repositioned along axis F to its disengaged position. Biasing the door latch 190 to the deployed position also returns the cylindrical housing 270 of the secondary latch 260 to the lowed position. As the door 140 is closed with the door latch 190 in the deployed position, the end of the cylindrical portion of the door latch 190 strikes one of the ramps 126 of the housing 124 of the second gate frame member 120, which causes the door latch 190 to laterally slide into the top door housing 148 along axis E, compressing resilient member 230, until the door latch 190 is aligned with the cavity 125 of the housing 124 of the second gate frame member 120. Once the door latch 190 is aligned with the cavity 125 of the housing 124 of the second gate frame member 120, the resilient member 230 biases the door latch 190 into the deployed position and into the cavity 125 of the housing 124 of the second gate frame member 120. Furthermore, as the door 140 is closing and the lower shaft 274 of the cylindrical housing 270 contacts the ramped threshold 136, the lower shaft 274 is forced upward into the cylindrical housing 270 without the cylindrical housing 270 also moving upward. As soon as the lower shaft 274 aligns with the locking aperture 138, the lower shaft 274 lowers into the locking aperture 138.

In a remotely actuated operation, which is activated by the user operating the remote actuator 500 as further described below, the motor 176, set of gears 178, and rack member 180 are moved to reposition the door latch 190 along axis E. When the control assembly 290 of the safety gate 10 receives a signal from the remote actuator 500 to unlock the door 140, the control assembly sends a command signal to the motor 176 to begin rotating the set of gears 178. As the pinion gear 179 rotates, because the pinion gear's gear teeth are intermeshed with the gear teeth of the geared portion 186 of the rack member 180, the rack member 180 translates or slides along axis E. Depending on the position of the rack member 180 with respect to the door latch 190, the rack member 180 may translate along axis E until the pin 184 of the rack member 180 is disposed at the end of the slots 192 that is disposed farthest from the second side 156 of the top door housing 148 before the translation of the rack member 180 also causes the door latch 190 to translate along axis E toward the first side 154 of the top door housing 148. Because the cylinder portion 182 of the rack member 180 is at least partially disposed within the central cavity 206 of the door latch 190, and because the pin 184 is disposed within both slots 192 of the door latch 190, when the pin 184 is located at the end of the slots 192 that is disposed farther from the second side 156 of the top door housing 148, translation of the rack member 180 along axis E toward the first side 154 of the top door housing 148 causes the rack member 180 to pull the door latch 190 along axis E toward the first side 154 of the top door housing 148. Furthermore, the door latch 190 may translate or slide along axis E until the ramp member 200 of the door latch 190 contacts the first switch 240. Once the rack member 180 has been fully repositioned laterally along axis E, and, as a result the door latch 190 has been fully repositioned laterally long axis E to the stowed position, the door latch 190 may no longer be disposed within the cavity 125 of the upper housing 124 of the second gate frame member 120. Moreover, as similarly described with the manual operation, as the door latch 190 slides or translates along axis E, the elongate member 262 of the secondary latch 260 is pulled by the lower end 198 of the flange 194 of the door latch 190. In other words, the first end 264 of the elongate member 262 is pulled such that the elongate member 262 is at least partially rolled around the roller 263 and the second end 268 of the elongate member 262 and the cylindrical housing 270 are pulled upwardly along axis H to lift the lower shaft 274 out of the locking aperture 138. With the door latch 190 no longer extending into the cavity 125 of the upper housing 124 of the second gate frame member 120 and the lower shaft 274 no longer extending into the locking aperture 138 of the bottom frame rail 130, the door 140 is free to be rotated about axis D to reposition the door from the closed position A to the opened position B.

When using the remote actuator 500 to unlock or unlatch the door 140 to rotate, the control assembly 290 of the safety gate may determine or sense if the door 140 has been rotated to the opened position. As illustrated in FIG. 4E, the control assembly 290 of the safety gate 10 may include a sensor 292 to determine if the door 140 is in the opened or closed position. In one embodiment, the sensor 292 may be a hall switch or hall effect sensor that detects the magnitude of a magnetic field. In this embodiment, the housing 124 of the second gate frame member 120 may include one or more magnets to enable the control assembly 290 to determine, based on readings by the sensor 292, whether or not the door 140 is in the closed position A or the opened position B. When the door latch 190 is positioned in the stowed position by actuation of the remote actuator 500, and the control assembly 290 determines via sensor 292 that the door is in the opened position, the control assembly 290 causes the door latch 190 to translate or slide along axis E back to the deployed position. Moreover, if the control assembly 290 determines that the door 140 has not been moved from the closed position A within a predetermined amount of time (e.g., 5 seconds, 10 seconds, etc.) after the latch mechanism 170 has been activated via the remote actuator 500, then the control assembly 290 causes the door latch 190 to translate back to the deployed position to lock the door 140 to the closed position A. The latch mechanism 170 performs identical operations when the closing the door 140 after using the remote operation to unlock the door 140 as that described above when closing the door 140 after using the manual operation to unlock the door 140.

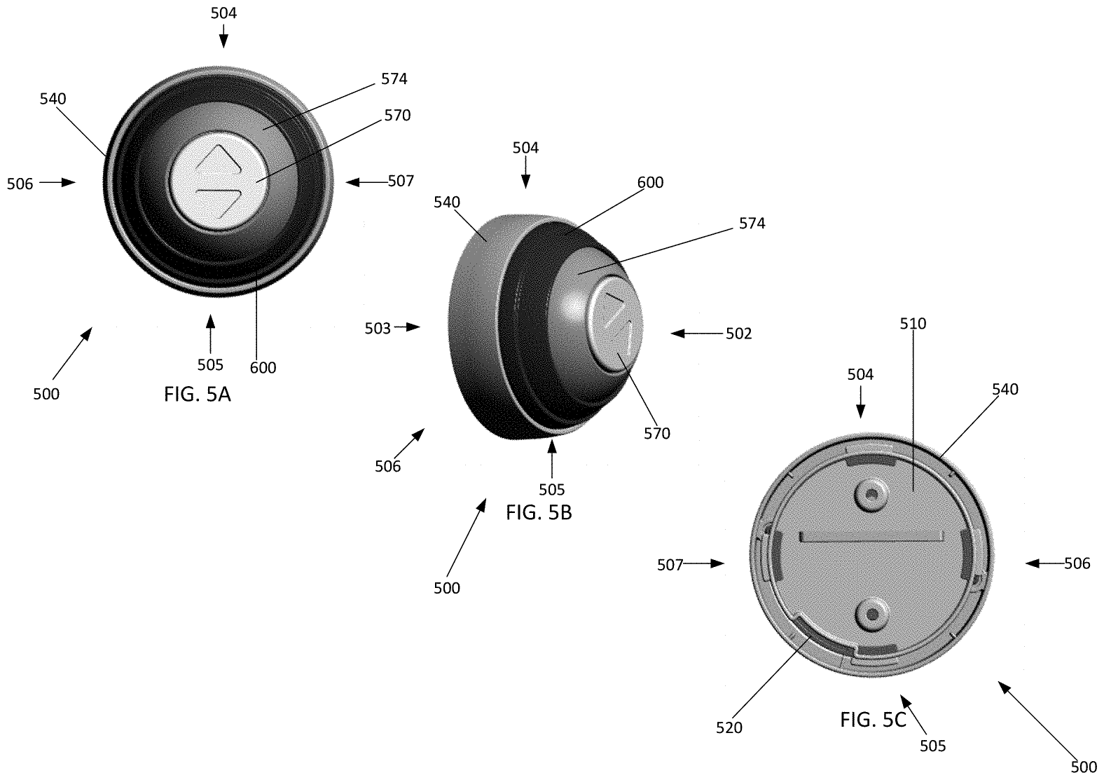

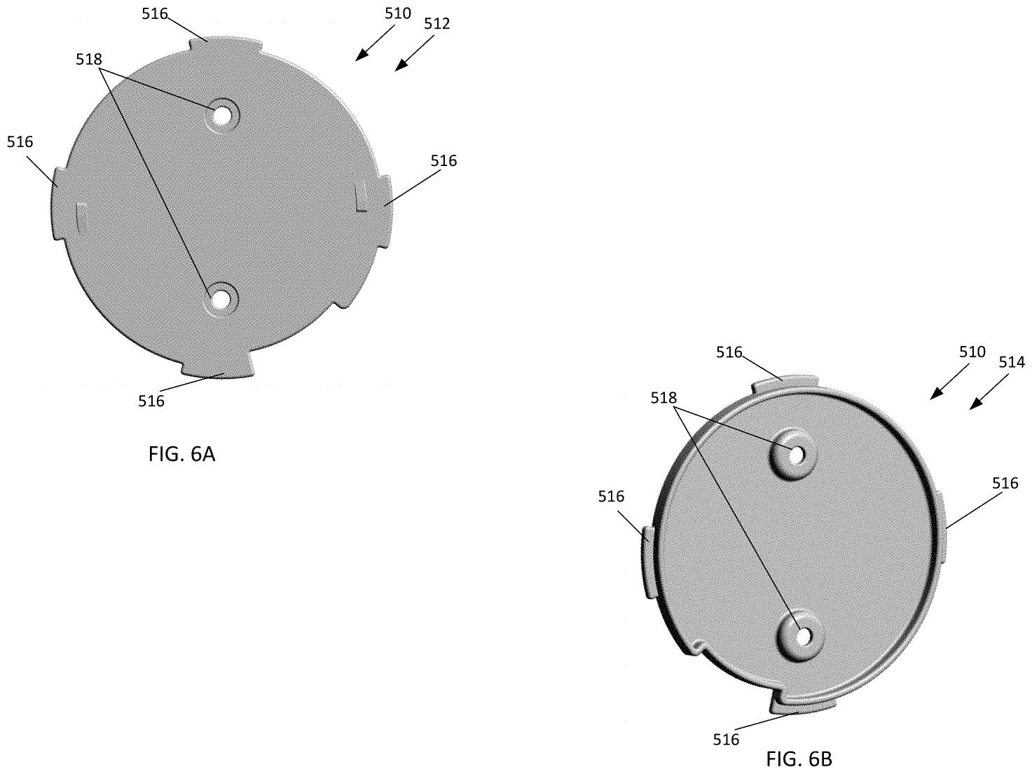

Turning to FIGS. 5A-5C illustrated are various views of the remote actuator 500, while FIGS. 6A, 6B, 7A, 7B, 8A, 8B, 9A, 9B, 10A, 10B, 11A, 11B, 12A, 12B, 13A, 13B, and 13C illustrate various components of the remote actuator and various combinations of those components attached to each other. As illustrated in FIGS. 5A, 5B, and 5C, the remote actuator 500 is substantially dome-shaped having a front or button side 502, a rear or wall side 503 opposite the front side 502, a top side 504, and a bottom side 505 opposite the top side 504. The remote actuator 500 further includes a first side 506 and an opposite second side 507.

As illustrated in FIG. 5C, the remote actuator 500 contains a wall mount plate 510 proximate to the rear side 503 of remote actuator 500. FIGS. 6A -6B illustrate isolated views of the wall mount plate 510, where FIG. 6A illustrates the interior side 512 of the wall mount plate 510, and FIG. 6B illustrates the exterior side 514 of the wall mount plate 510. As further illustrated, the wall mount plate 510 includes a series of tabs 516 extending from the periphery edge of the wall mount plate 510 such that the series of tabs 516 extend radially outward from the periphery edge. The wall mount plate 510 further includes one or more openings 518 that extend through the wall mount plate 510 from the exterior side 514 to the interior side 512. The one or more openings 518 are configured to receive fasteners (e.g., screws, nails, etc.) to secure the wall mount plate 510 to a wall or other surface.

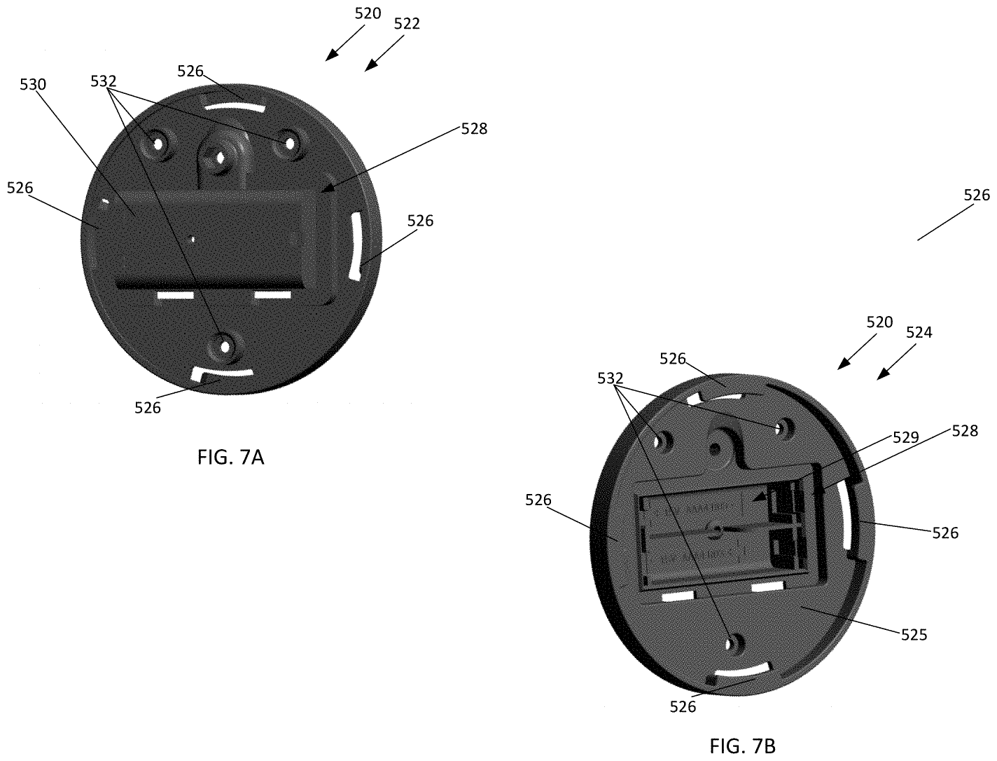

FIGS. 7A and 7B illustrate views of the first or innermost side 522 (FIG. 7A) and the second or outermost side 524 (FIG. 7B) of the battery box panel 520. The battery box panel 520 contains a planar surface 525 on the outermost side 524 and a series of tab receptacles 526 disposed around the periphery of the battery box panel 520. The series of tab receptacles 526 of the battery box panel 520 may be equivalent in number to the series of tabs 516 of the wall mount plate 510. However, unlike the series of tabs 516 of the wall mount plate 510, where the tabs 516 extend from the periphery edge of the wall mount plate 510 such that the series of tabs 516 extend radially outward from the periphery, the series of tab receptacles 526 of the battery box panel 520 extend radially inward from the periphery of the battery box panel 520 (i.e., towards the center of the battery box panel 520) and are spaced from the planar surface 525 of the battery box panel 520 such that the series of tab receptacles 526 form areas defined between the series of tab receptacles 526 and the planar surface 525 for receiving the series of tabs 516 of the wall mount plate 510. The series of tab receptacles 526 of the battery box panel 520 are configured to receive the series of tabs 516 of the wall mount plate 510 to secure the battery box panel 520 to the wall mount plate 510.

The battery box panel 520 further includes a battery box 528 centrally located with a depression 529 in the planar surface 525 of the outermost side 524, where the depression is configured to receive one or more batteries. While not illustrated, the depression 529 of the battery box 528 may be configured to receive a cover. As further illustrated, the innermost side 522 contains a centrally located extension 530 that extends from the innermost side 522 and is aligned with the depression 529 of the outermost side 524. The battery box panel 520 further includes one or more openings 532 that are disposed around the planar surface 525 of the battery box panel 520 such that the one or more openings 532 extend through the planar surface 525 the battery box panel 520 from the outermost side 524 through to the innermost side 522.

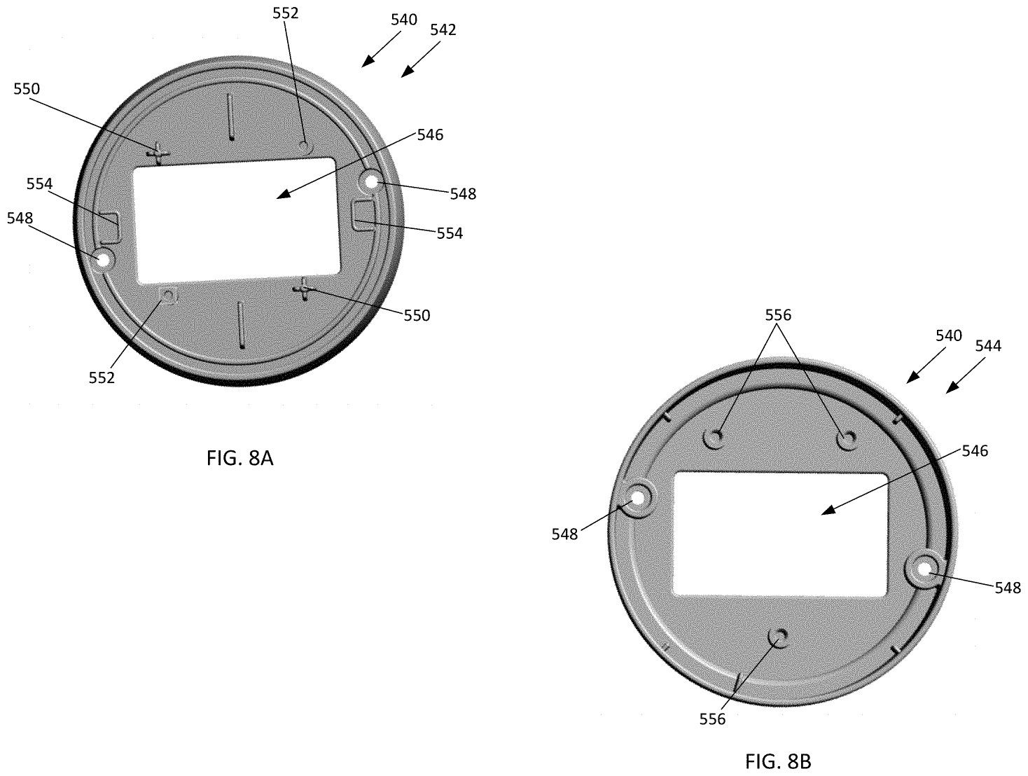

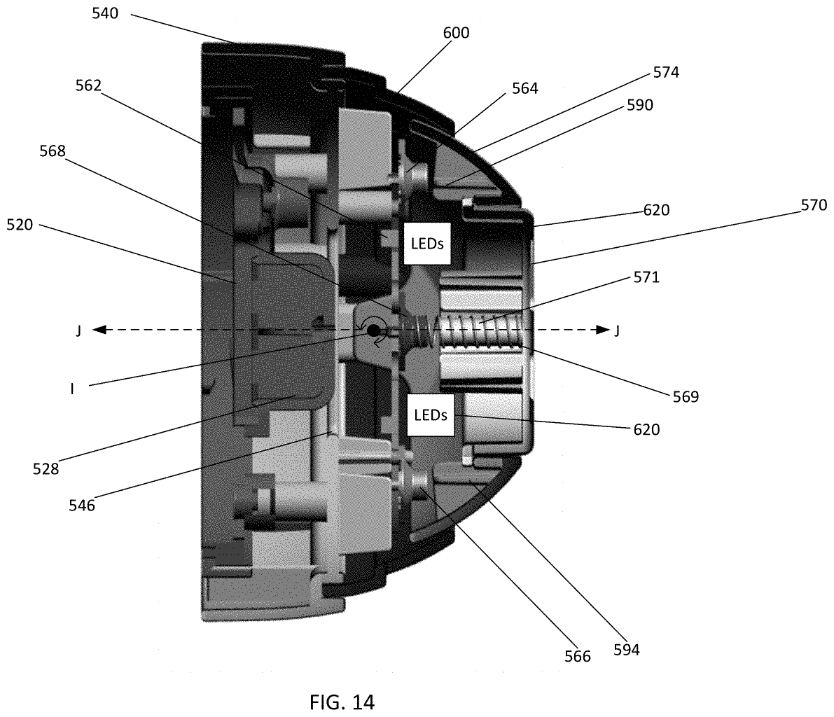

FIGS. 8A and 8B illustrate views of the first side 542 (FIG. 8A) and the second side 544 (FIG. 8B) of the actuator base 540. The actuator base 540 contains a centrally located aperture 546 that extends through the actuator base 540 from the first side 542 to the second side 544. The actuator base 540 further includes a pair of openings 548 that extend through the actuator base 540 from the first side 542 to the second side 544. As illustrated, the pair of openings 548 are disposed proximate to the periphery of the actuator base 540, where one is disposed on one side of the central aperture 546 and the other is disposed on the opposite side of the central aperture 546. The first side 542 further includes protuberances 550 that extend from the first side 542 proximate to and around the central aperture 546. In addition, first side 542 also includes fastener openings 552 that extend from the first side 542 proximate to and around the central aperture 546. FIG. 8A also illustrates that the first side 542 contains a pair of retention extensions 554 that extend from the first side 542 on opposing sides of the central aperture 546. The retention extensions 554 illustrated in FIG. 8A are U-shaped, but in other embodiments, the retentions extensions 554 may be of any other shape. As illustrated in FIG. 8B, disposed on the second side 544 of the actuator base 540 is one or more fastener openings 556. The number of fastener openings 556 may be equivalent to the number of openings 532 of the battery box panel 520. Moreover, when the innermost side 522 of the battery box panel 520 is disposed against the second side 544 of the actuator base 540, the one or more fastener openings 556 of the actuator base 540 may align with the one or more openings 532 to enable one or more fasteners (e.g., screws, bolts, etc.) to secure the battery box panel 520 to the actuator base 540. Furthermore, as best illustrated in FIG. 14, when the innermost side 522 of the battery box panel 520 is disposed against the second side 544 of the actuator base 540, the battery box 528 extends at least partially into the central aperture 546.

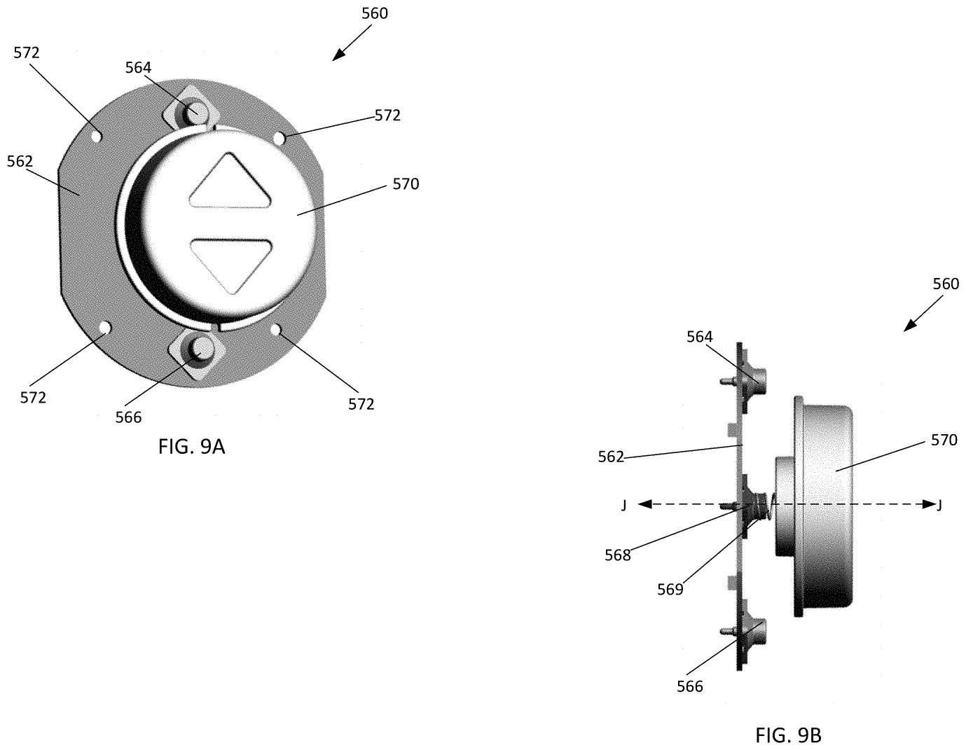

Turning to FIGS. 9A and 9B, illustrated is a front perspective view (FIG. 9A) and a side view in elevation (FIG. 9B) of portions of the actuator mechanism 560 of the remote actuator 500. The actuator mechanism 560 includes a PCB plate 562, disposed on which is a first or top switch 564 and a second or bottom switch 566. As best illustrated in FIG.9B, the PCB plate 562 also includes a third or central switch 568. Extending from the PCB plate 562 proximate to, and directly aligned with, the central switch 568 is a resilient member 569. Coupled to the end of the resilient member 569 and spaced away from the PCB plate 562 is an actuator cover 570 that, in the embodiment illustrated, contains an upward arrow and a downward arrow. As best illustrated in FIG. 9A, the PCB plate 562 further includes openings 572 that extend through the PCB plate 562.

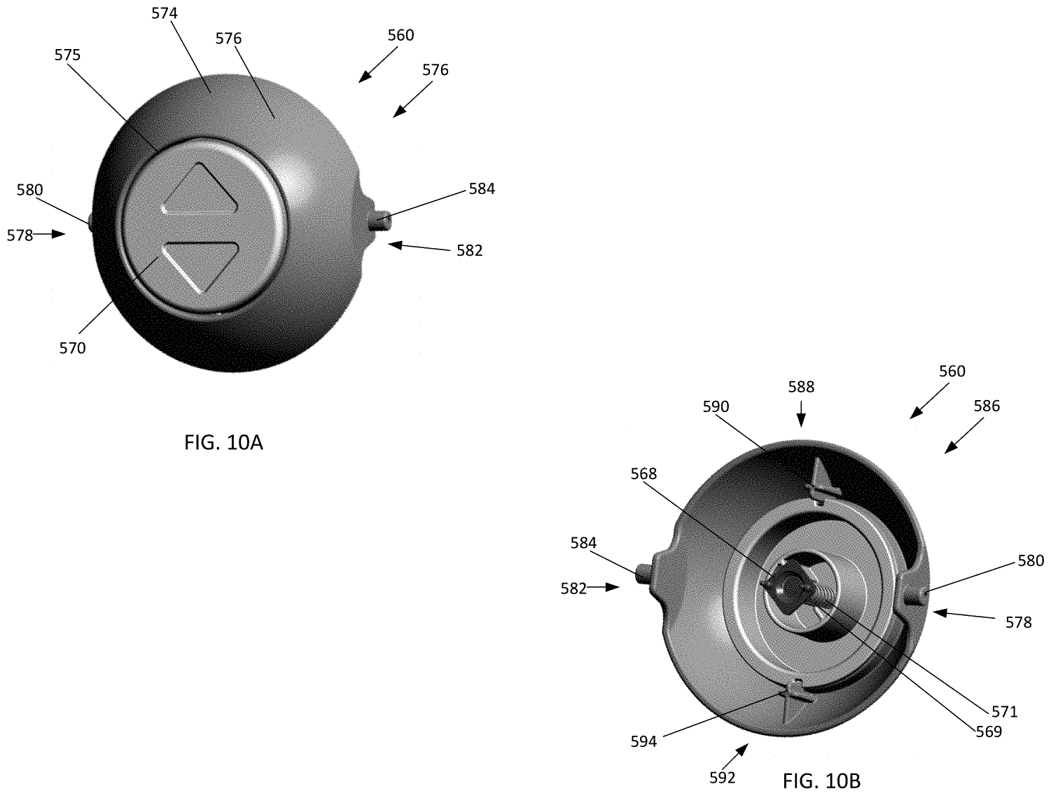

Turning to FIGS. 10A and 10B, illustrated is a front view (FIG. 10A) and a rear view (FIG. 10B) of an actuator housing 574 with the actuator cover 570 at least partially disposed within the actuator housing 574. The actuator housing 574 contains an exterior side 576 and an interior side 586 with a central aperture 575 disposed within and extending through the actuator housing 574 between the exterior side 576 and the interior side 586. The exterior side 576 further includes a first cylindrical extension 580 extending outwardly from a first side 578 of the actuator housing 574, and a second cylindrical extension 584 extending outwardly from a second side 582 of the actuator housing 574 (i.e., the first and second cylindrical extensions extend from the actuator housing 574 opposite one another and in opposing directions). As best illustrated in FIG. 10B, the interior side 586 of the actuator housing 574 includes a first contact extension 590 extending from the interior side 586 proximate to a top end 588 of the actuator housing 574, and a second contact extension 594 extending from the interior side 586 proximate to a bottom end 592 of the actuator housing 574. The actuator cover 570 is disposed between the first contact extension 590 and the second contact extension 594, and at least partially extends through the central aperture 575 of the actuator housing 574. As further illustrated in FIG. 10B, the actuator cover 570 includes a central contact member 571, of which the resilient member 569 is disposed around.

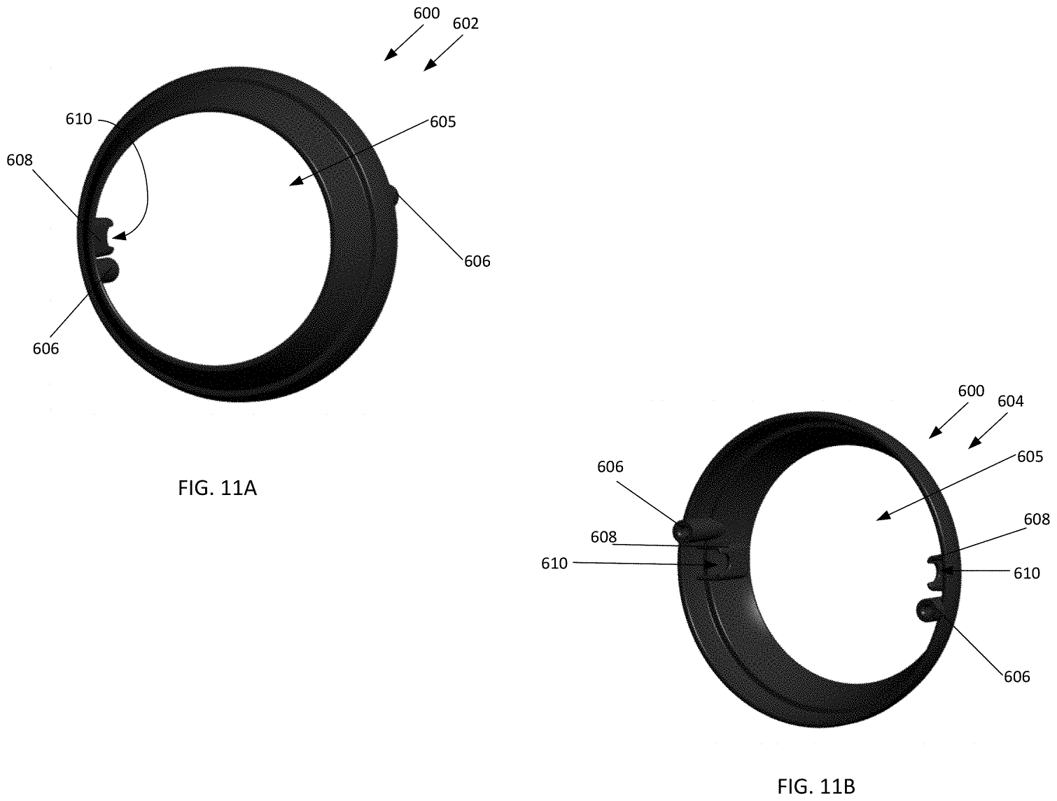

Turning to FIGS. 11A and 11B, illustrated is a front view (FIG. 11A) and a rear view (FIG. 11B) of an LED cover 600. As illustrated, the LED cover 600 includes an exterior side 602 and an interior side 604. The LED cover 600 further includes a central aperture 605 that extends through the LED cover 600 between the exterior side 602 and the interior side 604. The interior side 604 may contain two protuberances 606 that are disposed on, and extend from, the interior side 604 proximate to the periphery of the LED cover 600. The LED cover 600 may further include two extension housings 608 that extend from the interior side 604 of the LED cover 600, where the extension housings 608 extend from the interior side 604 proximate to the periphery of the central aperture 605. Each of the extension housings 608 may include a channel 610.

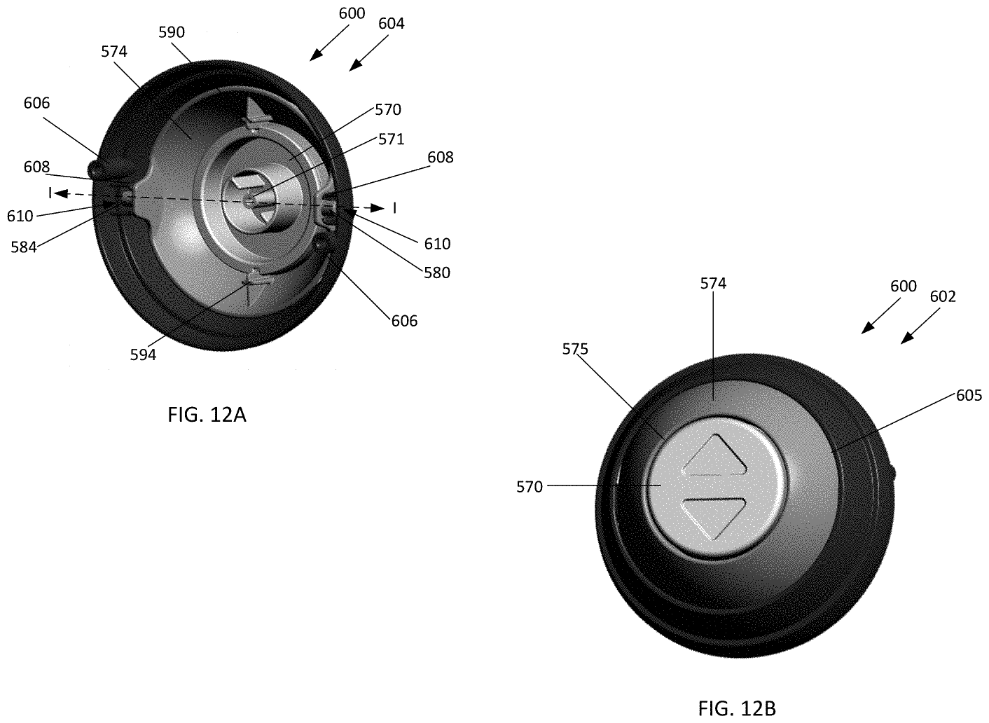

FIGS. 12A and 12B illustrate various views of the actuator cover 570 disposed within the actuator housing 574, which is disposed in the LED cover 600. The actuator cover 570, as preciously explained, is disposed within the central aperture 575 of the actuator housing 574 such that the actuator cover 570 is disposed between the first and second contact extensions 590, 594. When the actuator housing 574 is disposed within the LED cover, the actuator housing 574 extends through the central aperture 605 of the LED cover 600 such that the actuator housing 574 extends outwardly from the exterior side 602 of the LED cover 600. Moreover, as best illustrated in FIG. 12A, when the actuator housing 574 is disposed within, and coupled to, the LED cover 600, the first and second cylindrical extensions 580, 584 are received in the channels 610 of the extension housings 608 on the interior side 604 of the LED cover 600. Thus, the actuator housing 574, and subsequently the actuator cover 570, rotate with respect to the LED cover 600 about axis I that extends through the first and second cylindrical extensions 580, 584 of the actuator housing 574.

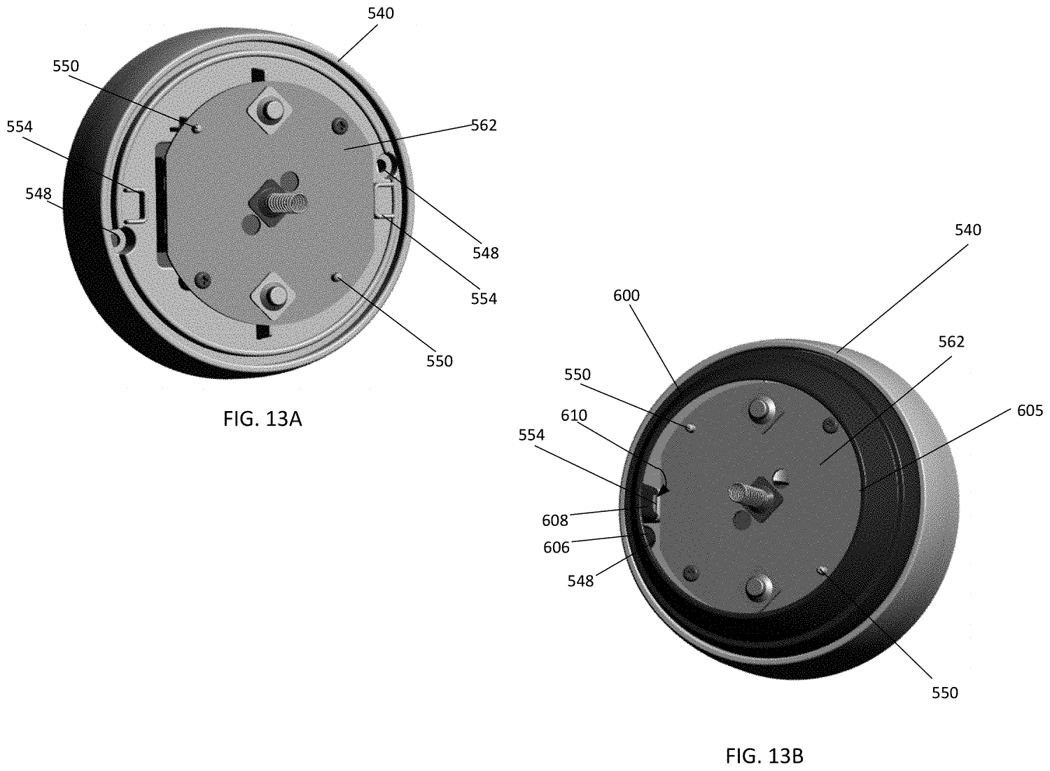

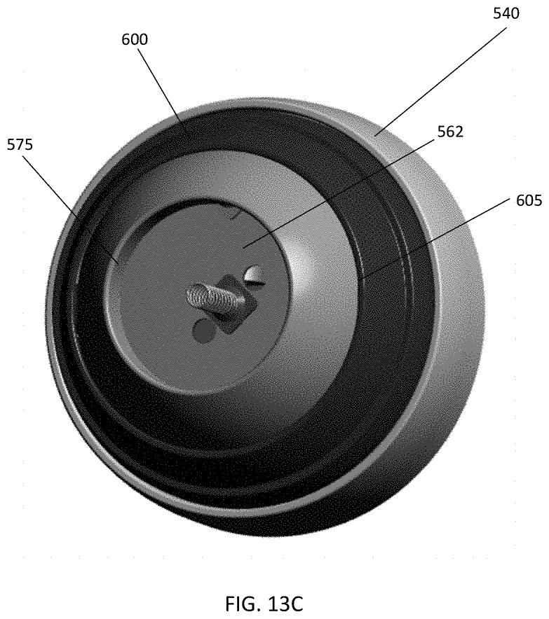

Turning to FIG. 13A, illustrated is the PCB plate 562 of the actuator mechanism 560 coupled to the actuator base 540. The openings 572 of the PCB plate 562 align with the protuberances 550 and the fastener openings 552 disposed around the central aperture 546 of the actuator base 540. As illustrated, the two openings 572 of the PCB plate 562 that align with the protuberances 550 of the actuator base 540 receive at least a portion of the protuberances 550, while the two openings 572 of the PCB plate 562 that align with the fastener openings 552 of the actuator base 540 are configured to receive fasteners (e.g., screws, bolts, etc.) that secure the PCB plate 562 to the actuator base 540.

As illustrated in FIG. 13B, when the LED cover 600 is coupled to the actuator base 540, the protuberances 606 on the interior side of the LED cover 600 are aligned with the pair of openings 548 around the periphery of the actuator base 540, such that fasteners (e.g., screws, bolts, etc.) may be inserted into the pair of openings 548 to secure the LED cover 600 to the first side 542 of the actuator base 540. In addition, when the LED cover 600 is secured to the first side 542 of the actuator base 540, the extension housings 608 of the LED cover 600 are received by the retention extensions 554 of the actuator base 540. While not illustrated in FIG. 13B or FIG. 13C (which shows the actuator housing 574 disposed within the central aperture 605 of the LED cover 600), when the cylindrical extensions 580, 584 of the actuator housing 574 are received in the channels 610 of the extension housings 608, and the extension housings 608 are received by the retention extensions 554 of the actuator base 540, the cylindrical extensions 580, 584 of the actuator housing 574 are retained or secured within the channels 610 of the extension housings 608 by the retention extensions 554.

As illustrated in FIG. 14, which is a cross sectional view of the remote actuator 500, the battery box panel 520 is affixed to the second side 544 of the actuator base 540, and is at least partially disposed within the second side 544 of the actuator base 540. As explained previously, the battery box panel 520 may be removably coupled to the wall mount plate 510 when the wall mount plate 510 is secured to a wall or other surface because the series of tab receptacles 526 of the battery box panel 520 are configured to receive the series of tabs 516 of the wall mount plate 510 to secure the battery box panel 520 to the wall mount plate 510. More specifically, the outermost side 524 of the battery box panel 520 may be placed against the interior side 512 of the wall mount plate 510 such that the series of tab receptacles 526 of the battery box panel 520 are misaligned with the series of tabs 516 of the wall mount plate 510. The remote actuator 500 is then rotated with respect to the wall mount plate 510 (i.e., approximately a quarter rotation when the number of tabs is four) to slide the series of tabs 516 of the wall mount plate 510 into the series of tab receptacles 526 of the battery box panel 520, which secures the battery box panel 520, and subsequently the entire remote actuator 500, to the wall mount plate 510 mounted on a wall. Because the PCB plate 562, the actuator cover 570, the actuator housing 574, and the LED cover 600 of the remote actuator 500 are secured to the actuator base 540, and because the actuator base 540 is secured to the battery box panel 520, when the battery box panel 520 is removably coupled to the wall mount plate 510, the remote actuator 500 is removably secured to the wall or other surface to which the wall mount plate 510 is affixed.

As further illustrated in FIG. 14, when the remote actuator 500 is fully assembled the central contact member 571 of the actuator cover 570 is in close proximity to the central switch 568 of the PCB plate 562, while the first contact extension 590 of the actuator housing 574 is in close proximity to the first switch 564 of the PCB plate 562 and the second contact extension 594 of the actuator housing 574 is in close proximity to the second switch 566 of the PCB plate 562. As further illustrated in FIG. 14, the remote actuator 500 may house one or more LEDs 620 that may be coupled to the PCB plate 562, and are configured to shine or illuminate through the LED cover 600, the actuator cover 570, and/or the actuator housing 574.

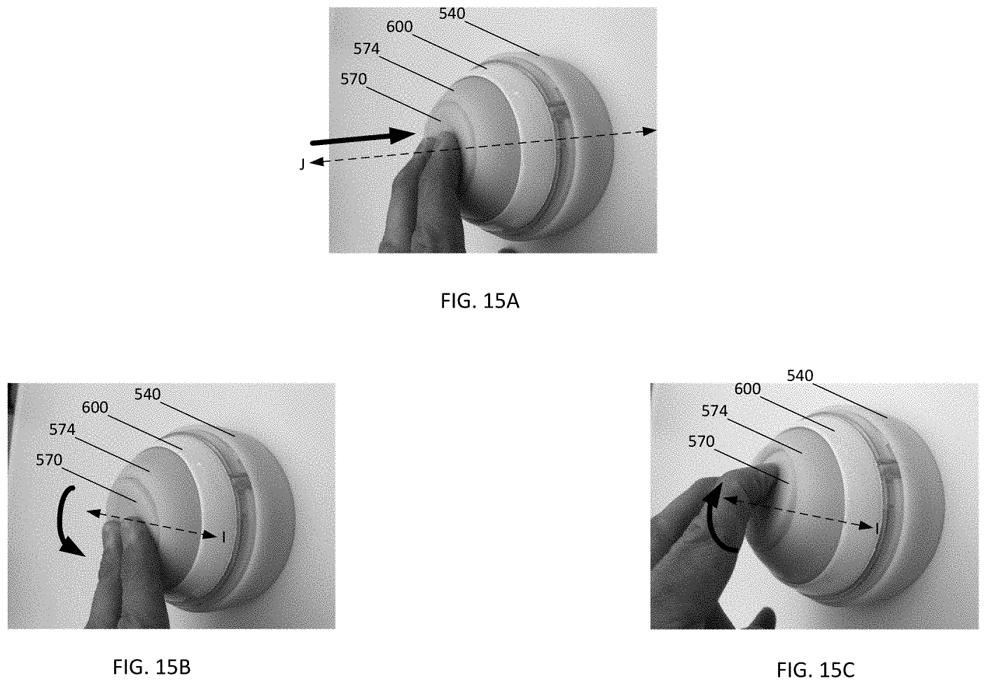

With reference to FIGS. 14 and 15A-15C, the remote actuator 500 may require three steps in order to actuate the remote actuator 500. First, as illustrated in FIGS. 14 and 15A, the actuator cover 570 of the remote actuator 500 may be depressed along axis J (i.e., moved or reconfigured to a first position) such that the resilient member 569 is compressed and the central contact member 571 contacts and depresses the central switch 568. After the central switch 568 has been actuated, as illustrated in FIGS. 14 and 15B, the actuator cover 570 and the actuator housing 574 are rotated downwardly about axis I (i.e., moved or reconfigured to a second position) such that the second contact extension 594 contacts and depresses the second switch 566. Finally, after the second switch 566 has been actuated, as illustrated in FIGS. 14 and 15C, the actuator cover 570 and the actuator housing 574 are rotated upwardly about axis I (i.e., moved or reconfigured to a third position) such that the first contact extension 590 contacts and depresses the first switch 564. In other embodiments, the switches 564, 566, 568 may be actuated in any other manner and any other order. In even further embodiments, only one or two of the switches 564, 566, 568 may need to be actuated in order actuate the remote actuator 500.

The remote actuator 500 illustrated in FIGS. 5A-5C, 6A, 6B, 7A, 7B, 8A, 8B, 9A, 9B, 10A, 10B, 11A, 11B, 12A, 12B, 13A-13C, 14, and 15A-15C may be used to remotely actuate the latch mechanism 170 of the safety gate 10 via the remotely actuated operation described above. The remote actuator 500 may be configured to communicate with the control assembly/PCB 290 of the safety gate 10 to operate the latch mechanism 170. The control assembly 290 and the remote actuator 500 may communicate wirelessly via one of several types of communications, including RF (radio frequency), IR (infrared), audio, video, Bluetooth, WiFi, ZigBee, or other known wireless communications.

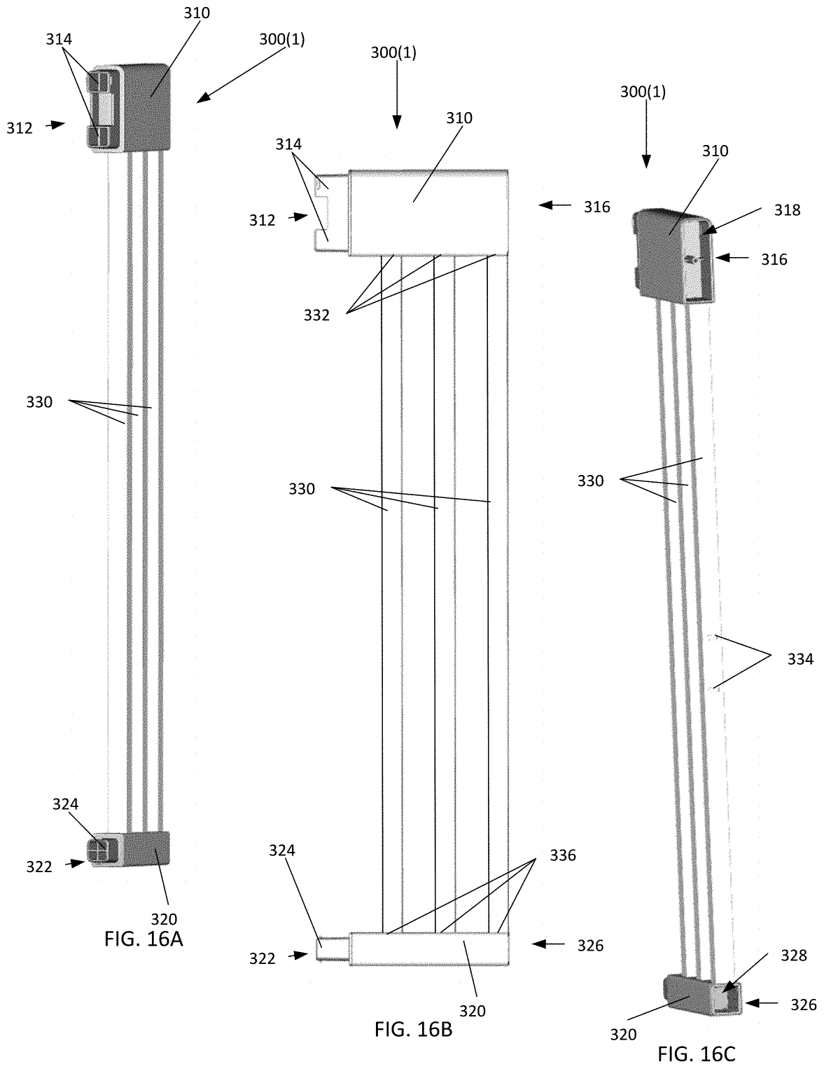

Turning to FIGS. 16A-16C, illustrated is one extension frame member 300(1) of the plurality of extension frame members 300(1), 300(2), 300(3) of the safety gate 10 illustrated in FIGS. 1A-1C. While FIGS. 16A-16C illustrated only extension frame member 300(1), the discussion of FIGS. 16A-16C applies to each extension frame member 300(1), 300(2), 300(3), as each extension frame member 300(1), 300(2), 300(3) only differs in width and the number of rails included on the extension frame member 300(1), 300(2), 300(3), which is based on the width of the extension frame member 300(1), 300(2), 300(3).

As illustrated in FIG. 16A, 16B, and 16C, the extension frame member 300(1), includes a upper housing 310, a lower housing 320, and a set of rails 330 extending between the upper housing 310 and the lower housing 320. As illustrated best in FIGS. 16A and 16B, the upper housing 310 has a first side 312 and a second side 316 opposite the first side 312. As illustrated in FIGS. 16A and 16B, the upper housing 310 includes a set of protrusions 314 that extend from the first side 312 of the upper housing 310. Furthermore, as best illustrated in FIG. 16C, the upper housing 310 contains a receptacle 318 that is disposed within the second side 316 of the upper housing 310. The protrusions 314 of the upper housing 310 are configured to be received within the receptacle 116 of the upper housing 114 of the first gate frame member 110 of the gate frame 100, the receptacle 127 of the upper housing 124 of the second gate frame member 120 of the gate frame 100, or one of the receptacles 318 of the upper housings 310 of the other extension frame members 300(2), 300(3).

Similar to the upper housing 310, the lower housing 320 has a first side 322 and a second side 326 opposite the first side 322. As illustrated in FIGS. 16A and 16B, the lower housing 320 includes a protrusion 324 that extends from the first side 322 of the lower housing 320. Furthermore, as best illustrated in FIG. 16C, the lower housing 320 contains a receptacle 328 that is disposed within the second side 326 of the lower housing 320. The protrusion 324 of the lower housing is configured to be received within the receptacles 133, 135 of the bottom frame rail 130 of the safety gate frame 100, or one of the receptacles 328 of the lower housings 320 of the other extension frame members 300(2), 300(3).

As further illustrated in FIGS. 16A-16C, each of the rails 330 of the extension frame member 300(1) includes an upper end 332 and a lower end 336. The upper ends 332 of the rails 330 are coupled to the upper housing 310, while the lower ends 336 of the rails 330 are coupled to the lower housing 320. As further illustrated, the rail 330 that is coupled to the upper and lower housings 310, 320 most proximate to the second sides 316, 326 of the upper and lower housings 310, 320, respectively, contains a set of apertures 334.

The plurality of extension frame members 300(1), 300(2), 300(3) may be used to connect to the wall clamping members 400(1), 400(2) and/or the safety gate frame 100 to increase the length of the safety gate 10 to fit within a threshold or doorway. In one embodiment, extension frame member 300(1) may add six inches to the length of the safety gate 10, extension frame member 300(2) may add four inches to the length of the safety gate 10, and extension frame member 300(3) may add two inches to the length of the safety gate 10. Any of the plurality of extension frame members 300(1), 300(2), 300(3), any combination of the plurality of extension frame members 300(1), 300(2), 300(3), or none of the plurality of extension frame members 300(1), 300(2), 300(3) may be used in conjunction with the wall clamping members 400(1), 400(2) to form the safety gate 10 with the safety gate frame 100. When all three extension frame members 300(1), 300(2), 300(3) are used with the safety gate frame 100 and the wall clamping members 400(1), 400(2), the extension frame members 300(1), 300(2), 300(3) add a total of 12 inches in length to the safety gate 10.

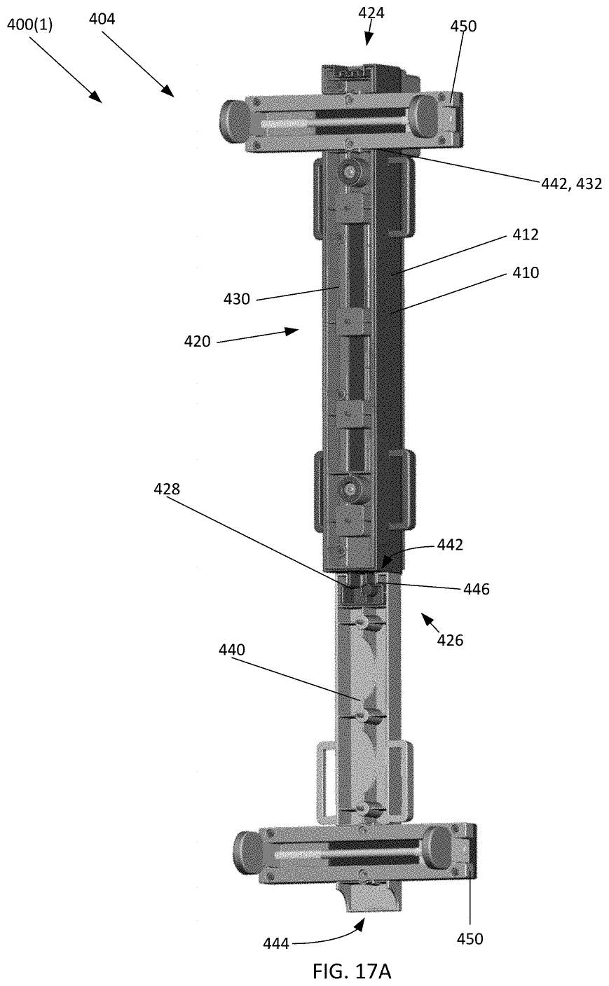

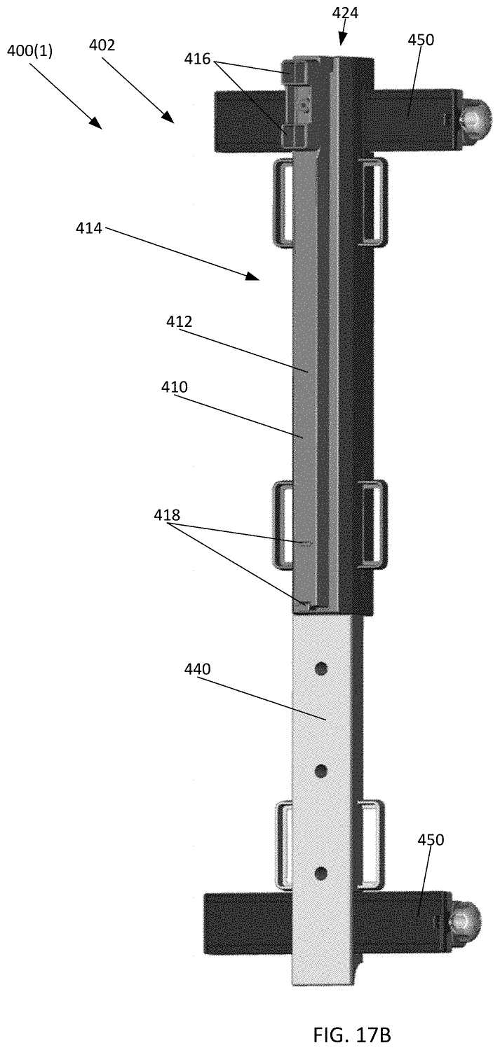

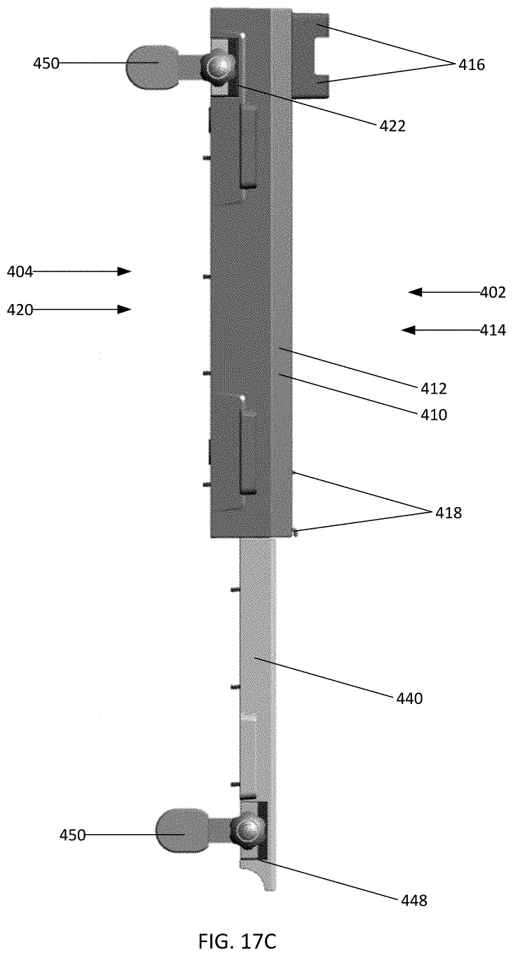

Turning to FIGS. 17A-17C, illustrated is one wall clamping member 400(1) of the multiple wall clamping members 400(1), 400(2) of the safety gate 10 illustrated in FIGS. 1A-1C. While FIGS. 17A-17C illustrate only wall clamping member 400(1), the discussion of FIGS. 17A-17C applies to both wall clamping members 400(1), 400(2), as both wall clamping members 400(1), 400(2) are merely mirror images of one another and, thus, are nearly identical to one another.

As illustrated in FIGS. 17A-17C, the wall clamping member 400(1) contains a safety gate facing side 402 and a clamping or wall facing side 404. The wall clamping member 400(1) further includes an upper portion 410 and a lower portion 440 coupled to one another. The upper portion 410, as illustrated, includes an outer member 412 that encompasses an inner member 430. The outer member 412 of the wall clamping member 400(1) includes an exterior side 414, an interior side 420, a top end 424, and a bottom end 426. As best illustrated in FIGS. 17B and 17C, the exterior side 414 of the outer member 412 of the upper portion 410 of the wall clamping member 400(1) contains protrusions 416 disposed proximate to the top end 424 of the outer member 412. The protrusions 416 are similar to the protrusions 314 of the upper housing 310 of the first extension frame member 300(1) in that the protrusions 416 of the wall clamping member 400(1) are configured to be received within the receptacle 116 of the upper housing 114 of the first gate frame member 110 of the gate frame 100, the receptacle 127 of the upper housing 124 of the second gate frame member 120 of the gate frame 100, or one of the receptacles 318 of the upper housings 310 of the extension frame members 300(1), 300(2), 300(3). As further illustrated in FIGS. 17B and 17C, the outer member 412 of the upper portion 410 of the wall clamping member 400(1) also contains tabs 418 disposed proximate to the bottom end 426 of the outer member 412. As best illustrated in FIG. 17A, the bottom end 426 of the outer member 412 may include a T-shaped extension member 428 that extends from the bottom end 426. As best illustrated in FIG. 17A, the inner member 430 is disposed within the interior side 420 of the outer member 412. Furthermore, the outer member 412 includes a receiving slot 422 on the interior side 420, while the inner member430 includes a similar sized receiving slot 432 that aligns with the receiving slot 422 of the outer member 412 when the inner member 430 is disposed within the outer member 412. The receiving slots 422, 432 are disposed proximate to the top end 424 of the outer member 412 of the upper portion 410 and configured to receive at least one clamp assembly 450, which is further detailed below.

Continuing with FIGS. 17A-17C, the lower portion 440 of the wall clamping member 400(1) includes a top end 442 and a bottom end 444 opposite the top end 442. The top end 442 of the lower portion 440 includes a receiving aperture 446 that is sized and shaped to receive the T-shaped extension member of the outer member 412, which is best illustrated in FIG. 17A. In addition, the lower portion 440 contains a receiving slot 448 that is configured to receive at least clamp assembly 450. The lower portion 440 may be removed from the upper portion 410 when the wall to which the safety gate 10 is to be clamped contains a baseboard that prevents the clamping assembly 450 of the lower portion 440 from being able to clamp the wall.

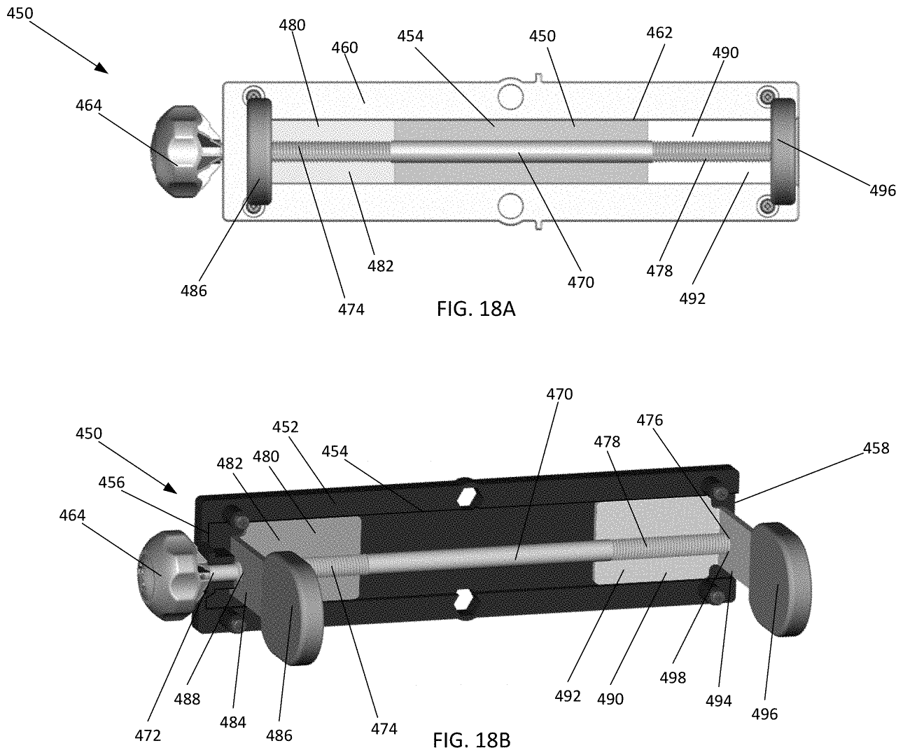

Turning to FIGS. 18A and 18B, illustrated is a clamping assembly 450 of the wall clamping member 400(1). The clamping assembly 450 includes a backplate 452 and a cover plate 460 coupled to the backplate 452, where both the backplate 452 and the cover plate 460 may be rectangular. As best illustrated in FIG. 18B, the backplate 452 includes a channel 454 that spans across the backplate 452, where the channel 454 contains a first side 456 and a second side 458. The cover plate 460 may be attached to the front side of the backplate 452, and the cover plate 460 may include a central aperture 462 that is aligned with the channel 454 and at least partially exposes the channel 454. As best illustrated in FIG. 18B, slidably received within the channel 454 of the backplate 452 are two L-shaped sliding members 480, 490. The first sliding member 480 contains a first portion 482 and a second portion 484, where the first portion 482 is disposed within the channel 454 of the backplate 452. The second portion 484 forms a right angle with the first portion 482, and extends forwardly from the backplate 452 through the central aperture 462 of the cover plate 460. Disposed on an end of the second portion 484 is a wall engagement member 486. The second portion 484 also includes an aperture 488. The second sliding member 490 is substantially similar to the first sliding member 480 except that the second sliding member 490 is a mirror image to the first sliding member 480. Thus, like the first sliding member 480, the second sliding member 490 contains a first portion 492 and a second portion 494, where the first portion 492 is disposed within the channel 454 of the backplate 452. The second portion 494 forms a right angle with the first portion 492, and extends forwardly from the backplate 452 through the central aperture 462 of the cover plate 460. Disposed on an end of the second portion 494 is a wall engagement member 496. The second portion 494 of the second sliding member 490 also includes an aperture 498.

As further illustrated in FIGS. 18A and 18B, the clamping assembly 450 also includes a screw drive 470. The screw drive 470 spans across the channel 454 of the backplate 452 and is disposed between the channel 454 of the backplate 452 and the cover plate 460. The screw drive 470 may be substantially cylindrical with a first end 472 and a second end 476. Both the first end 472 and the second end 476 contain a set of threads 474, 478, respectively. The threads 474 may be oriented in the opposite direction than the threads 478. The aperture 488 of the first sliding member 480 threadably receives the first end 472 and the threads 474 of the screw drive 470, while the aperture 498 of the second sliding member 490 threadably receives the second end 476 and the threads 478 of the screw drive 470. Disposed on the first end 472 of the screw drive 470 is a dial 464. In other embodiments, other mechanisms (e.g., lever, etc.) may be used in place of the dial 464. In operation, an operator turns the dial 464 to rotate the screw drive 470 of the clamping assembly 450. Because the threads 474, 478 are received by the sliding members 480, 490, respectively, and because the threads 474,478 are oppositely threaded to one another, as the dial is rotated in a first direction, the first and second sliding members 480, 490 slide towards one another along the channel 454. When the dial is rotated in a second direction that is opposite the first direction, the sliding members 480, 490 slide away from each other in the channel 454. This mechanism causes any object disposed between the sliding member 480, 490 to be centrally clamped along the clamping assembly 450 (i.e., the clamping assembly 450 self-centers an object being clamped). Thus, with the sliding members 480, 490 disposed at opposing ends of the channel 454, an operator may plate the safety gate 10 within a threshold (e.g., of a doorway or other passageway in which the safety gate 10 is desired). The operator then rotates the dial 464 in the first direction to cause the sliding members 480, 490 to slide towards one another until the wall engagement member 486 of the first sliding member 480 and the wall engagement member 496 of the second sliding member 490 are both in engagement with the wall/threshold and clamping assembly 450 is clamping the wall/threshold. With the clamping assemblies 450 secured to the wall clamping members 400(1), 400(2), and the wall clamping members 400(1), 400(2) secured to the safety gate frame 100, the safety gate 10 may be centrally secured within a threshold. This mounting mechanism (i.e., the use of the clamping assembly 450) improves upon traditional pressure mount mechanisms in that traditional pressure mount mechanisms are still capable of sliding through the threshold (i.e., causing the safety gate to become lose or disengaged from the threshold), while the clamping assembly 450 is incapable of sliding through a threshold due to the wall of the threshold being clamped on opposing sides of the wall by the sliding members 480, 490 of the clamping assembly 450. Thus, the clamping assembly 450 more securely and safely attaches the safety gate 10 within a threshold. Moreover, the clamping assembly 450 enables the safety gate 10 to be more easily placed centrally within the threshold, while traditional pressure mounts are more difficult to place centrally within the threshold.

In other embodiments, the clamping assembly 450 may not include dial 464. Instead, one or both of the ends 472, 476 of the screw drive 470 may include an indentation or series of indentations that are configured to receive, and be engage by, the end of a screwdriver or drill bit. Thus, an operator may engage one of the ends 472, 476 of the screw drive 470 with a screwdriver or drill bit in order to rotate the screw drive 470 of the clamping assembly 450 to cause the sliding members 480, 490 to slide towards one and engage a wall/threshold.

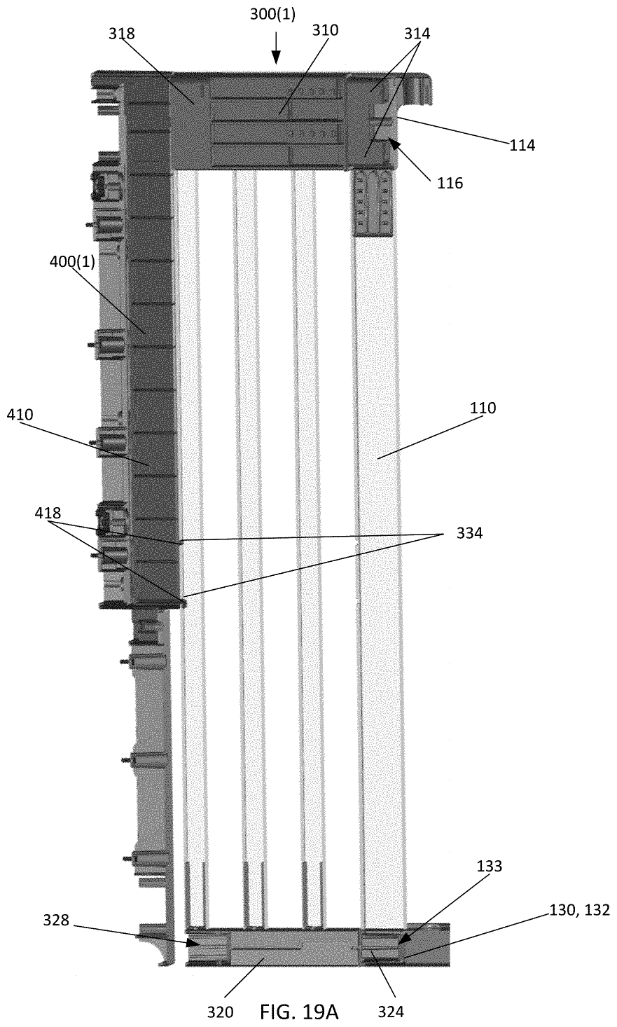

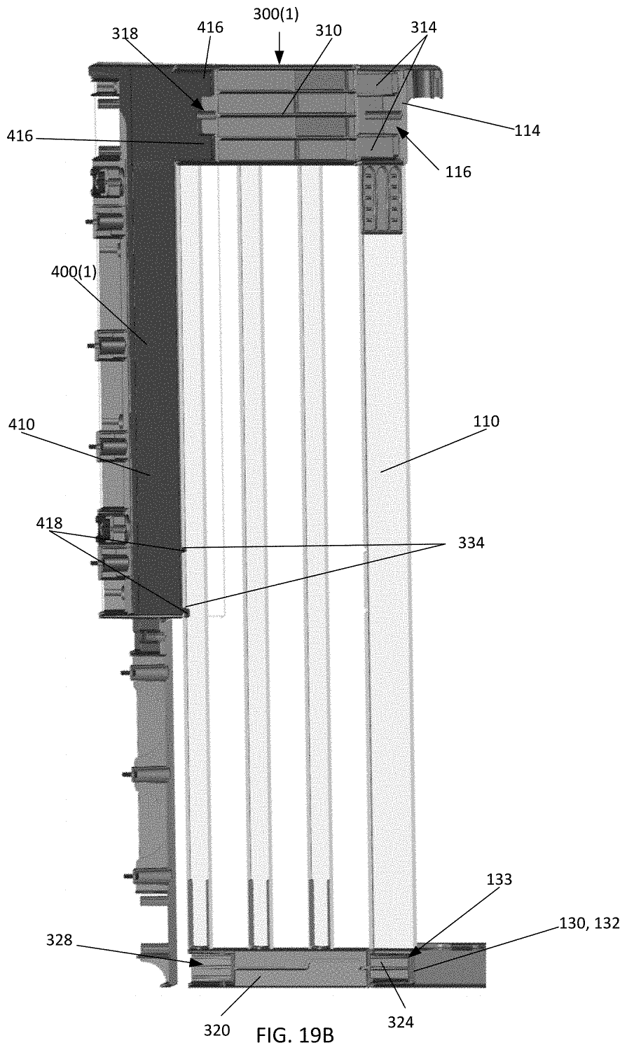

Turning to FIGS. 19A and 19B, illustrated are cross-sectional views of extension frame member 300(1) coupled to the safety gate frame 100, and wall clamping member 400(1) coupled to extension frame member 300(1). While extension frame members 300(2), 300(3) and wall clamping member 400(2) are not illustrated, the discussion of FIGS. 19A and 19B still apply to extension frame members 300(2), 300(3) and wall clamping member 400(2) because extension frame members 300(2), 300(3) are substantially similar to extension frame member 300(1), while wall clamping member 400(2) is substantially similar to wall clamping member 400(1), as described previously. As illustrated in FIG. 19A, the protrusions 314 of the upper housing 310 of the extension frame member 300(1) are received by, and disposed within, the receptacle 116 of the upper housing 114 of the first gate frame member 110 of the gate frame 100, while the protrusion 324 of the lower housing 320 of the extension frame member 300(1) is configured to be received within the receptacle 133 of the bottom frame rail 130 of the safety gate frame 100 to couple the extension frame member 300(1) to the safety gate frame 100. The protrusions 314, 324 of the extension frame member 300(1) friction fit within the receptacles 116, 133, respectively, of the safety gate frame 100. As best illustrated in FIG. 19B, the protrusions 416 of the wall clamping member 400(1) are received by, and disposed within, the receptacle 318 of the upper housings 310 of the extension frame member 300(1), while the tabs 418 of the wall clamping member 400(1) are received by the apertures 334 of the rail 330 of the extension frame member 300(1) to couple the wall clamping member 400(1) to the extension frame member 300(1). The protrusions 416 of the wall clamping member 400(1) friction fit within the receptacle of the extension frame member 300(1). In a similar manner, the wall clamping member 400(1) may also be coupled to the first gate frame member 110 or a second gate frame member 120, where the protrusions 416 of the wall clamping member 400(1) are received by, and disposed within, the receptacles 116, 127 of the upper housings 114, 124 of the first and second gate frame members 110, 120, respectively, while the tabs 418 of the wall clamping member 400(1) are received by the apertures 118, 128 of the rails 112, 122 of first and second gate frame members 110, 120, respectively, to couple the wall clamping member 400(1) to the door frame 100.

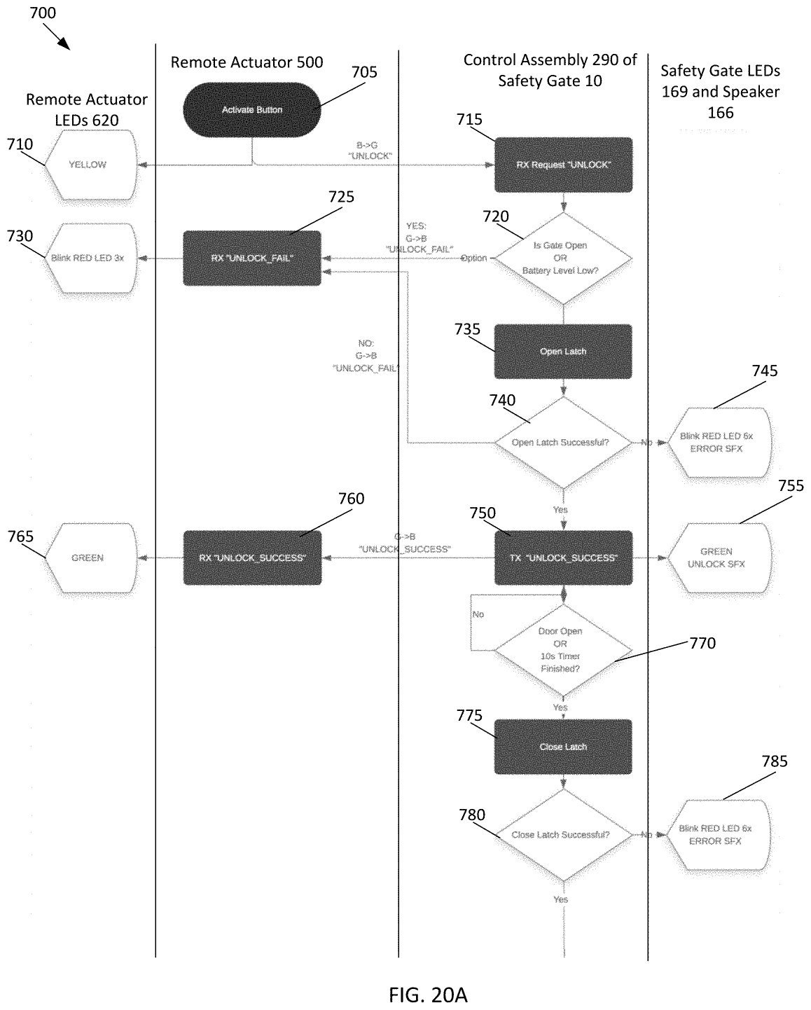

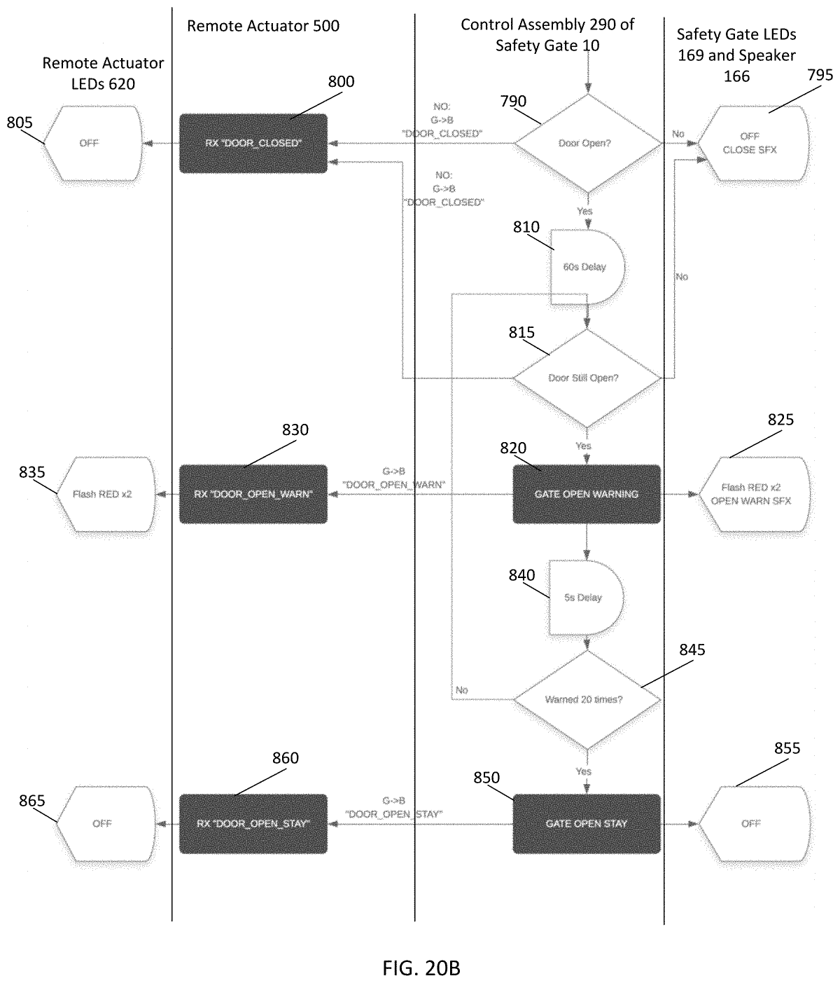

Turning to FIGS. 20A and 20B, illustrated is a flowchart depicting the order of operations 700 of the LEDs 620 of the remote actuator 500, the remote actuator 500, the latch mechanism 170 of the safety gate 10, the speaker 166 of the top door housing 148 of the safety gate 10, the LEDs 169 of the top door housing 148 of the safety gate 10, and the control assembly 290 of the safety gate 10. At 705, the remote actuator 500 is activated or actuated via the three-step actuation operation described above. Once actuated at 705, the remote actuator 500 commands the LEDs 620 to output a yellow visual light at 710, and sends a request to the safety gate 10 to request that the safety gate 10 be unlocked. At 715, the control assembly 290 the safety gate 10 receives the unlock request from the remote actuator 500. As 720, the control assembly 290 of the safety gate 10 verifies whether or not the door 140 is open and whether or not the battery levels of the safety gate 10 are low. If the control assembly 290 of the safety gate 10 determines at 720 that the door 140 is already open or that the battery levels are low, the control assembly 290 of the safety gate 10 sends the remote actuator 500 an unlock fail signal. At 725, the remote actuator 500 receives the unlock fail signal from the control assembly 290 of the safety gate 10 and instructs the LEDs 620 to, at 730, blink red three times.

However, if at 720, the control assembly 290 of the safety gate 10 determines that the door 140 is not open and determines that the battery levels are not low, the control assembly 290 of the safety gate 10, at 735, instructs the latch mechanism 170 to open the door latch 190 (i.e., instructs the motor 176 of the top door housing 148 to operate to cause the rack member 180 and the door latch 190 to slide or translate along axis E). At 740, the control assembly 290 of the safety gate 10 determines whether or not the door latch 190 was successfully opened. If the control assembly 290 of the safety gate 10 determines at 740 that the door latch 190 was not successfully opened, then, at 745, the control assembly 290 of the safety gate 10 instructs the LEDs 169 to blink red six times and instructs the speaker 166 to output an error sound effect as an audible output. However, if, at 740, the control assembly 290 of the safety gate 10 determines at 740 that the door latch 190 was successfully opened, then, at 750, the control assembly 290 of the safety gate 10 transmits to the remote actuator 500, the LEDs 169, and the speaker 166 that the door latch 190 successfully unlatched. This transmission at 750 causes, at 755, the LEDs 169 to output a green visual light, and the speaker 166 to output an unlock sound effect as an audible output. At 760, the remote actuator 500 receives the transmission from the control assembly 290 of the safety gate 10 at 750 that the door latch 190 was successfully unlocked, and instructs the LEDs 620, at 765, to emit a green light as a visual output.

At 770, the control assembly 290 of the safety gate 10 determines whether the door 140 is open and, if not, whether or not ten seconds have passed since the latch mechanism 170 was opened. If, at 770, the control assembly 290 of the safety gate 10 determines that the door 140 has not been opened and ten seconds have not passed since the latch mechanism 170 was opened, the control assembly 290 of the safety gate 10 returns to 770 to continue monitoring the state of the door 140. However, if the control assembly 290 of the safety gate 10 determines at 770 that the door 140 has been opened, or ten or more seconds have passed and the door 140 has not yet been opened, the control assembly 290 of the safety gate 10 at 775 instructs the latch mechanism 170 to close the door latch 190 (i.e., the control assembly 290 of the safety gate 10 sends a control signal to the motor 176 to slide or translate the rack member 180 and the door latch 190 along axis E toward the second side 156 of the top door housing 148). At 780, the control assembly 290 of the safety gate 10 determines whether the latch mechanism 170 has been successfully closed. If, at 780, the control assembly 290 of the safety gate 10 determined that the latch mechanism 170 was not successfully closed, then the control assembly 290 of the safety gate 10 transmits a command signal to the LEDs 169 and the speaker 166, which causes, at 785, the LEDs 169 to blink red six times and the speaker 166 to output an error sound effects as an audible output.

However, if, at 780, the control assembly 290 of the safety gate 10 determines that the latch mechanism 170 has closed successfully, then, at 790, as illustrated in FIG. 20B, the control assembly 290 of the safety gate 10 determines if the door 140 is in the opened position B. Continuing with FIG. 20B, if, at 790, the control assembly 290 of the safety gate 10 determines that the door 140 is in the closed position A, the control assembly 290 of the safety gate 10 transmits a control signal to the LEDs 169 and the speaker 166. At 795, the control signal from the control assembly 290 of the safety gate 10 causes the LEDs 169 and the speaker 166 to turn off and not output any outputs. Furthermore, at 790, if the control assembly 290 of the safety gate 10 determines that the door 140 is in the closed position A, the control assembly 290 of the safety gate 10 transmits a closed door signal to the remote actuator 500. At 800, the remote actuator 500 receives the closed door transmission from the control assembly 290 of the safety gate 10 and instructs the LEDs 620 to, at 805, turn off and not output any outputs.

If, at 790, the control assembly 290 of the safety gate 10 determines that the door 140 is in the opened position B, the control assembly 290 of the safety gate 10, at 810, begins a sixty second delay, where, sixty seconds later, the control assembly 290 of the safety gate 10, at 815, determines if the door 140 is still in the opened position B. If, at 815, the control assembly 290 of the safety gate 10 determines that the door 140 is in the closed position A, the control assembly 290 of the safety gate 10 transmits a control signal to the LEDs 169 and the speaker 166, at 795, where the control signal from the control assembly 290 of the safety gate 10 causes the LEDs 169 and the speaker 166 to turn off and not output any outputs. Furthermore, if, at 815, the control assembly 290 of the safety gate 10 determines that the door 140 is in the closed position A, the control assembly 290 of the safety gate 10 transmits a closed door signal to the remote actuator 500. At 800, the remote actuator 500 receives the closed door transmission from the control assembly 290 of the safety gate 10 and instructs the LEDs 620 to, at 805, turn off and not output any outputs.

However, if, at 815, the control assembly 290 of the safety gate 10 determines that the door 140 is still in the opened position B, then, at 820, the control assembly 290 of the safety gate 10 transmits a door open warning signal. The door open warning signal is transmitted to the LEDs 169 and the speaker 166 where, at 825, the signal instructs the LEDs 169 to flash red two times and the speaker 166 to output a door open warning sound effect as an audible output. At 830, the remote actuator 500 receives the door open warning signal from the control assembly 290 of the safety gate 10 at 820, which causes the remote actuator 500 to transmit a signal to the LEDs 620 to cause, at 835, the LEDs to flash red two times. After transmitting the door open warning signal, at 840, the control assembly 290 of the safety gate 10 begins timing a five second delay, and then, at 845, determines whether twenty door open warnings have been issued. If, at 845, the control assembly 290 of the safety gate 10 determines that the door open warning has not been issued twenty times, then the control assembly 290 of the safety gate 10 returns to step 815 to determine if the door 140 is still in the opened position B, and repeats steps 815-840. If, at 845, the control assembly 290 of the safety gate 10 determines that the door open warning has been issued 20 times, then, at 850, the control assembly 290 of the safety gate 10 transmits a door stay open signal. This door stay open signal instructs, at 855, the LEDs 169 and the speaker 166 to turn off and not output any output. At 860, the remote actuator 500 receives the door stay open transmission from the control assembly 290 of the safety gate 10 at 850, and instructs the LEDs 620, at 865 to turn off and not output any output.

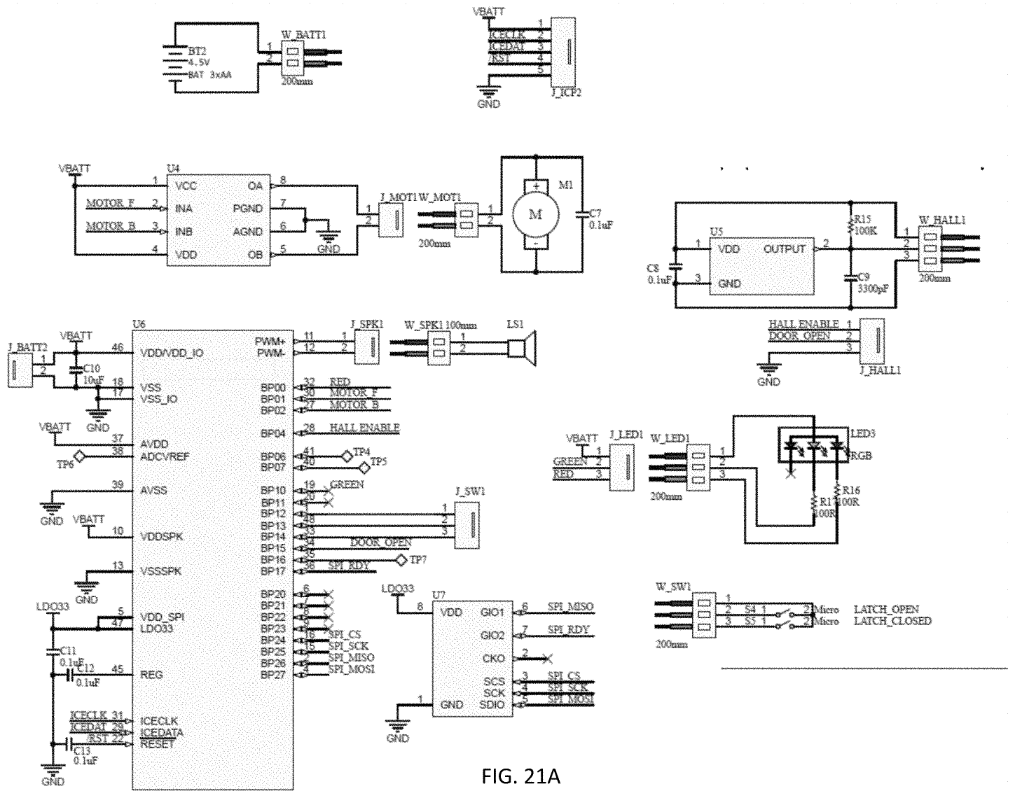

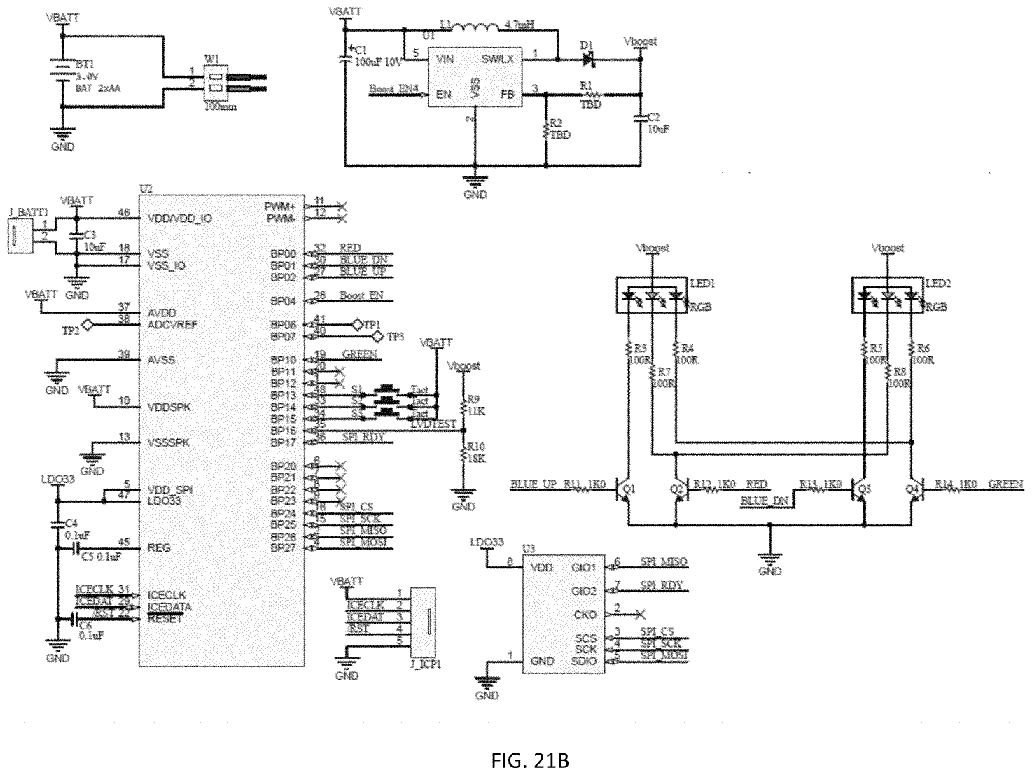

Turning to FIGS. 21A and 21B, illustrated are electrical schematic drawings of the electronics of the safety gate 10. FIG. 21A illustrates an electrical schematic drawing of the electronics of the top door housing 148 of the safety gate 10, while FIG. 21B illustrates an electrical schematic drawing of the electronics of the remote actuator 500 of the safety gate 10. The electronics of the top door housing 148 of the safety gate 10 and the electronics of the remote actuator 500 illustrated in the schematic drawings of FIGS. 21A and 21B are capable of performing the operations described and illustrated in FIGS. 20A and 20B.

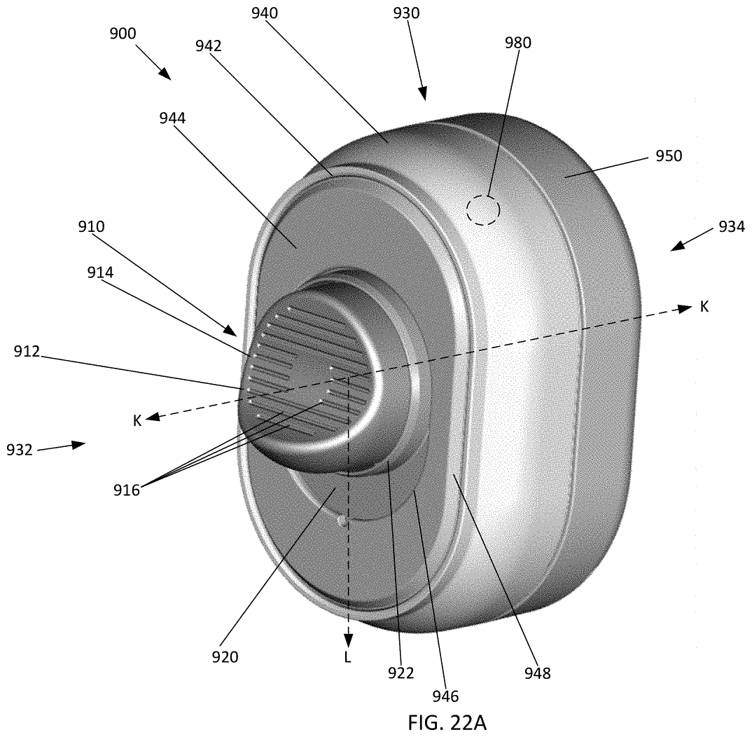

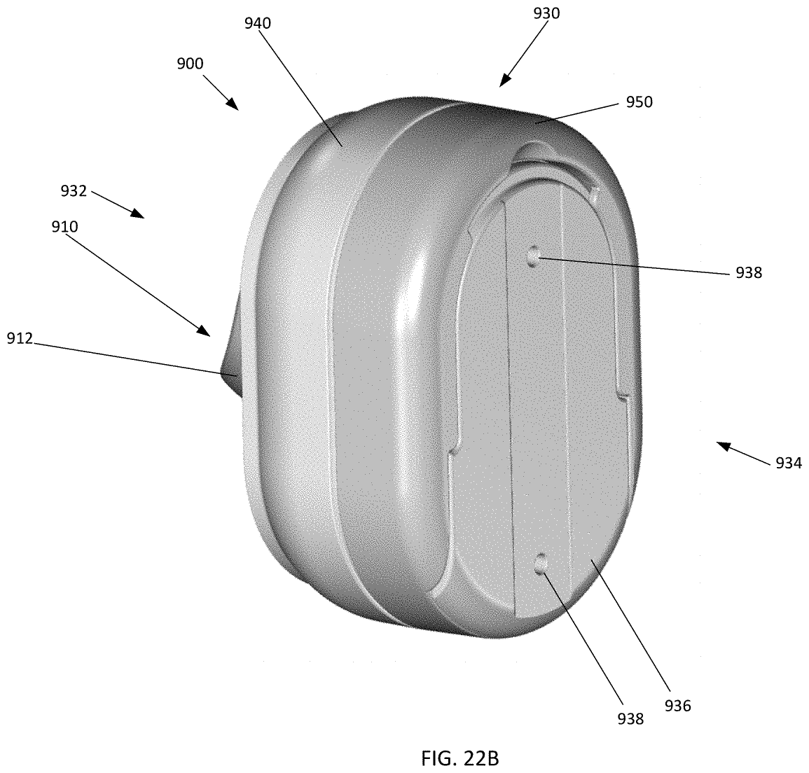

Turning to FIGS. 22A and 22B, illustrated is a second embodiment of the remote actuator 900. Like the first embodiment of the remote actuator 500, the second embodiment of the remote actuator 900 may be configured to wirelessly communicate with the control assembly/PCB 290 of the safety gate 10 to operate the latch mechanism 170. The control assembly 290 and the remote actuator 900 may communicate wirelessly via one of several types of communications, including RF (radio frequency), IR (infrared), audio, video, Bluetooth, WiFi, ZigBee, or other known wireless communications. As illustrated, the second embodiment of the remote actuator 900 includes a first housing portion 910 and a second housing portion 930, where the first housing portion 910 is configured to move with respect to the second housing portion 930.

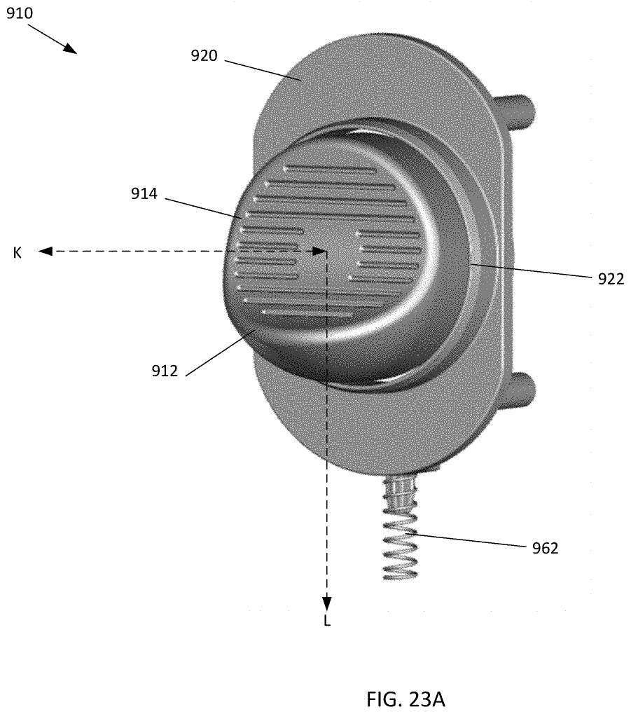

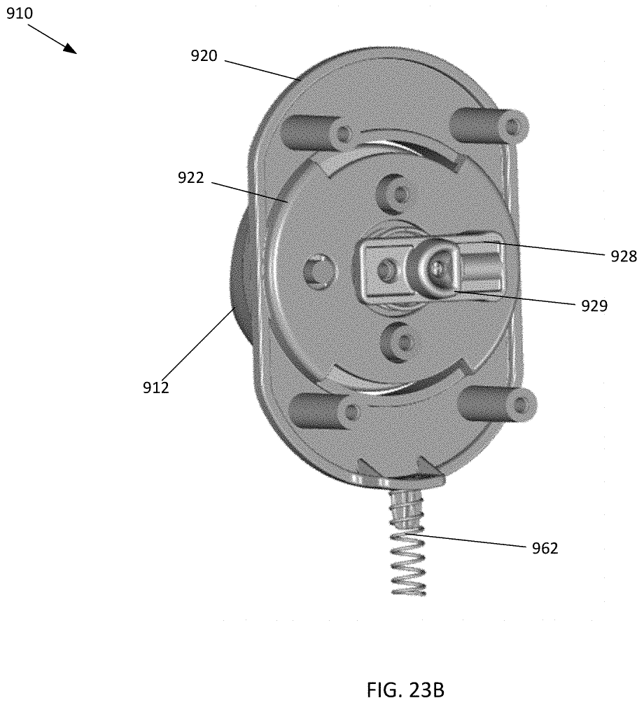

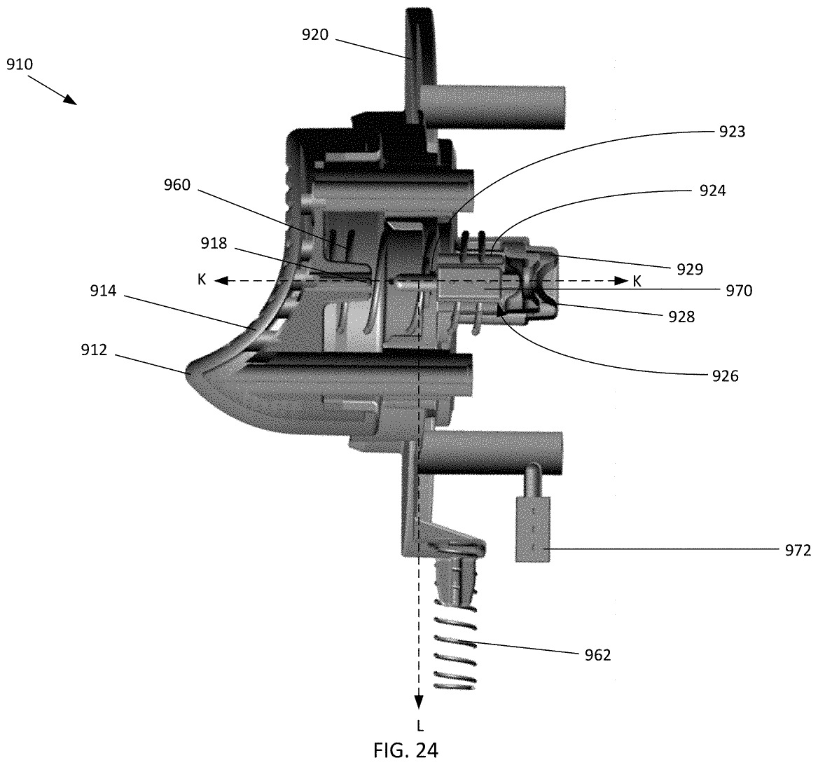

As illustrated in FIGS. 23A, 23B, and 24, and with continued reference to FIG. 22A, the first housing portion 910 includes a push button 912 and a sliding cover 920. The push button 912 may include a contact surface 914 disposed on the front side of the push button 912, where the contact surface 914 may have a curvature where the bottom side of the push button 912 may extend out horizontally a farther distance than the top side of the push button 912. The contact surface 914 of the push button 912 may further include a series of grip members 916 disposed thereon. The combination of the curvature of the contact surface 914 and the grip members 916 enable a user to contact and operate the push button 912 with a portion of their body (e.g., elbow, forearm, knee, etc.). This is especially helpful when an operator needs to operate the remote actuator 900 but their hands are full. As best illustrated in FIG. 24, the push button 912 may further include an extension member 918 disposed on the rear side of the push button 912.

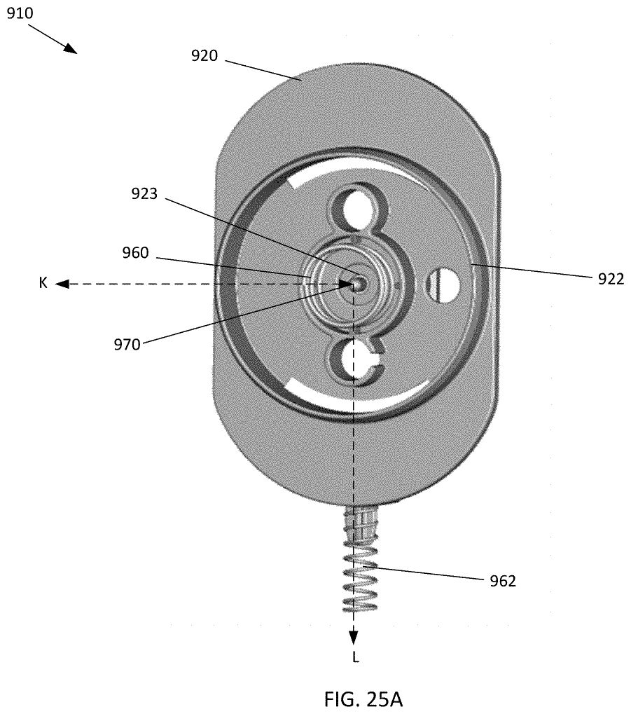

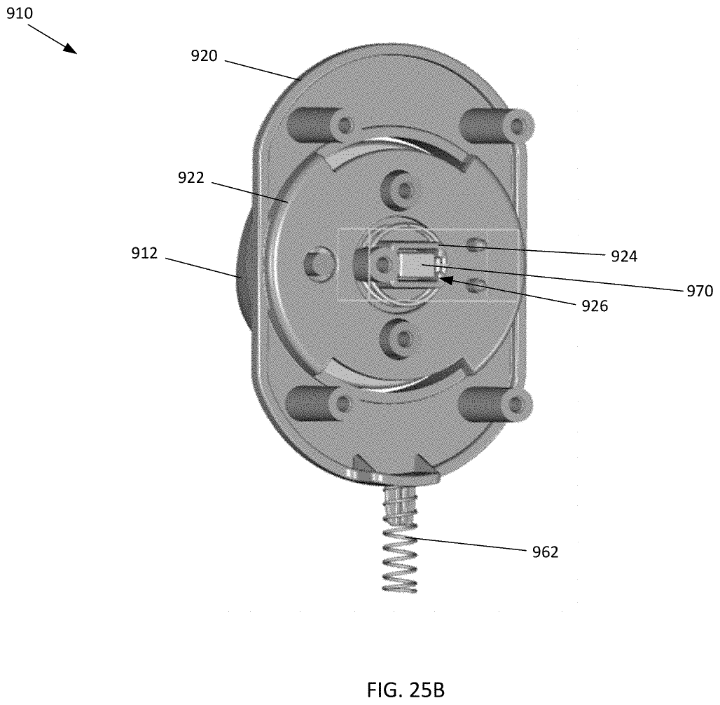

As illustrated in FIGS. 25A and 25B, and with continued reference to FIGS. 22A, 23A, 23B, and 24, the sliding cover 920 of the first housing portion 910 may include a front cavity 922 and a rear extension member 924. The front cavity 922 may be centrally disposed on the front side of the sliding cover 920, and, as illustrated in FIGS. 23A and 24, may be configured to at least partially receive the push button 912. The push button 912 may be configured to be depressed, or slide through, a portion of the front cavity 922 of the slide cover 920 along axis K. A first resilient member 960 may be disposed within the front cavity 922 to bias the push button 912 from the depressed position (i.e., biased the push button 912 out of the front cavity 922 such that the push button 912 does not remain fully inserted into the front cavity 922). As best illustrated in FIG. 25B, the rear extension member 924 may define a rear cavity 926 disposed in which is a first actuator switch 970. The sliding cover 920 may further include an opening 923 that extends between, and opens up to, the front cavity 922 and the rear cavity 926 of the rear extension member 924. As best illustrated in FIG. 24, the first actuator switch 970 disposed within the rear cavity 926 extends at least partially through the opening 923 and into the front cavity 922. As further illustrated in FIG. 24, the opening 923 and the first actuator switch 970 may be aligned along axis K with the extension member 918 of the push button 912.

Returning to FIGS. 23B and 24, disposed on the rear extension member 924 may be a cap 928, which is configured to retain the first actuator switch 970 within the rear cavity 926. The cap 928 may further include a protrusion 929 that, as explained in further detail below, is configured to contact and actuate the second actuator switch 972.

As further illustrated in FIGS. 23A, 23B, 24, 25A, and 25B, coupled to, or engaged with, the bottom end of the sliding cover 920 is a second resilient member 962.

Returning to FIGS. 22A and 22B, the second housing portion 930 of the second embodiment of the remote actuator 900 may include a front side 932 and a rear side 934. As further explained below, the rear side 934 may be configured to receive a mount plate 936 that enables the remote actuator 900 to be mounted on a wall or other surface. As best illustrated in FIG. 22A, the first housing portion 910, and more specifically, the push button 912 of the first housing portion 910, extends outwardly from the front side 932 of the second housing portion 930. In the embodiment illustrated, the second housing portion 930 may include a first housing half or base housing 940 and a second housing half or battery box housing 950, where the first housing half 940 and the second housing half 950 are coupled to one another to form the second housing portion 930. When coupled to one another, the first housing half 940 may be disposed more proximate to the front side 932 of the second housing portion 930 than the second housing half 950, while the second housing half 950 may be disposed more proximate to the rear side 934 of the second housing portion 930 than the first housing half 940.

As best illustrated in FIG. 22A, the first housing half 940 may include a front opening 942. Disposed in the front opening 942 may be a front cover 944. The front cover 944 may include a centralized channel 946 that is oriented to span along a vertical direction of the front cover 944. The front cover 944 may further include a translucent ring 948 that forms a border of the front cover 944, where the centralized channel 946 may be disposed within the translucent ring 948 (i.e., the translucent ring 948 may encircle the centralized channel 946). As further illustrated, the push button 912 and a portion of the sliding cover920 of the first housing portion 910 may extend through the centralized channel 946 of the front cover 944 of the first housing half 940 such that the push button 912 extends outwardly from the front side 932 of the second housing portion 930.

An illumination device or visual output device 980 may also be disposed within the remote actuator 900, and specifically within a cavity defined by the second housing portion 930 of the remote actuator 900. The translucent ring 948 may be configured to enable an output (e.g., light) of the visual output device 980 to pass through the translucent ring 948 so that it is visible to a user/operator of the remote actuator 900.

As best illustrated in FIGS. 22A, 24, and 26, the first housing portion 910 is configured to move with respect to the second housing portion 930. The first housing portion 910 is movably captured within the second housing portion 930, where, as previously explained, the push button 912 and a portion of the sliding cover 920 of the first housing portion 910 may extend through the centralized channel 946 of the front cover 944 of the first housing half 940 of the second housing portion 930. In a first type of movement (where the first housing portion 910 is moved or reconfigured to a first position with respect to the second housing portion 930), the push button 912 of the first housing portion 910 may be capable of being depressed or translated along axis/plane K. When depressed or translated along axis/plane K, the push button 912 at least partially slides through the front cavity 922 of the sliding cover 920, and at least partially slides through the centralize channel 946 of the first housing half 940 of the second housing portion 930 such that the push button 912 at least partially slides further into the second housing portion 930. As illustrated in FIGS. 22A, 23A, 23B, 24, and 26, the axis/plane K passes through the push button 912 of the first housing portion 910, the sliding cover 920 of the first housing portion 910, and the second housing portion 930. As best illustrated in FIG. 24, when the push button 912 is depressed along axis/plane K, the extension member 918 is configured to contact and actuate the first actuator switch 970. As previously explained, the first resilient member 960 may be configured to bias the push button 912 to the position illustrated, in which the push button 912 is not depressed.

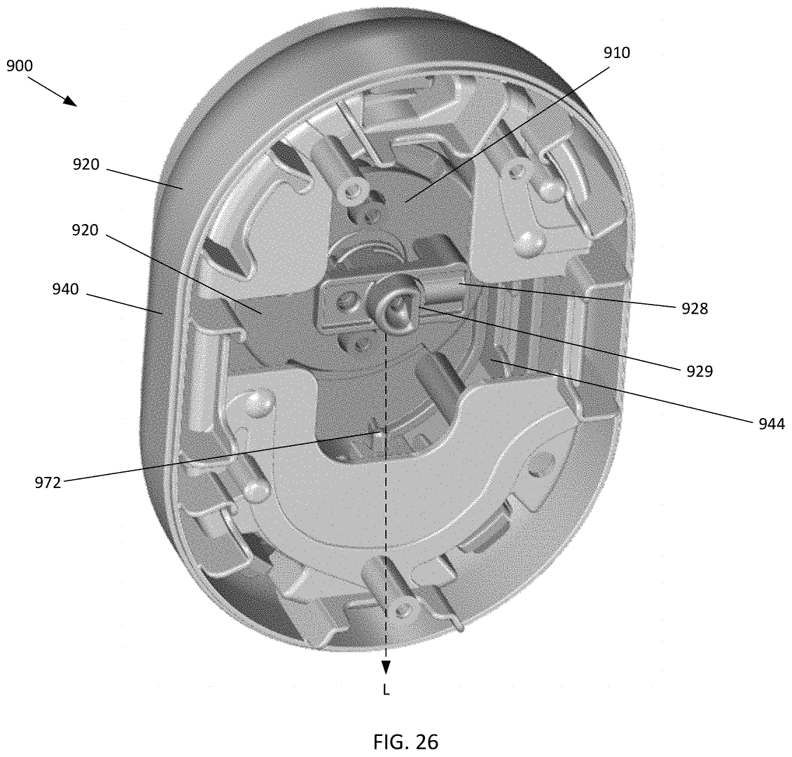

For the second type of movement (where the first housing portion 910 is moved or reconfigured to a second position with respect to the second housing portion 930, the second position being different from the first position), the first housing portion 910 may be capable of sliding downwardly along axis/plane L such that the first housing portion 910 slides along the centralized channel 946 of the front cover 944 of the first housing half 940 of the second housing portion 930. FIG. 22A shows the first housing portion 910 in the raised position, where the push button 912 is located proximate to the top end of the centralized channel 946. The first housing portion 910 may be configured to slide downwardly along axis/plane L, where the push button 912 slides along the length of the centralized channel 946 until the first housing portion 910 is in the lowered position. In the lowered position, the push button 912 may be located proximate to the bottom end of the centralized channel 946. The second resilient member 962, which is coupled to, or engaged with, the bottom end of the sliding cover 920 of the first housing portion 910, biases the first housing portion 910 to the raised position. As best illustrated in FIG. 26, when the first housing portion 910 is slid downwardly along axis/plane L, the protrusion 929 of the cap 928 that is coupled to the rear extension member 924 of the sliding cover 920 is configured to impact and actuate the second actuator switch 972.

In one embodiment, the first housing portion 910 may be capable of sliding along axis/plane L while the push button 912 of the first housing portion 910 is depressed along axis/plane K. In another embodiment, the first housing portion 910 may be capable of sliding along axis/plane L independent of whether or not the push button 912 of the first housing portion 910 has been depressed along axis/plane K.

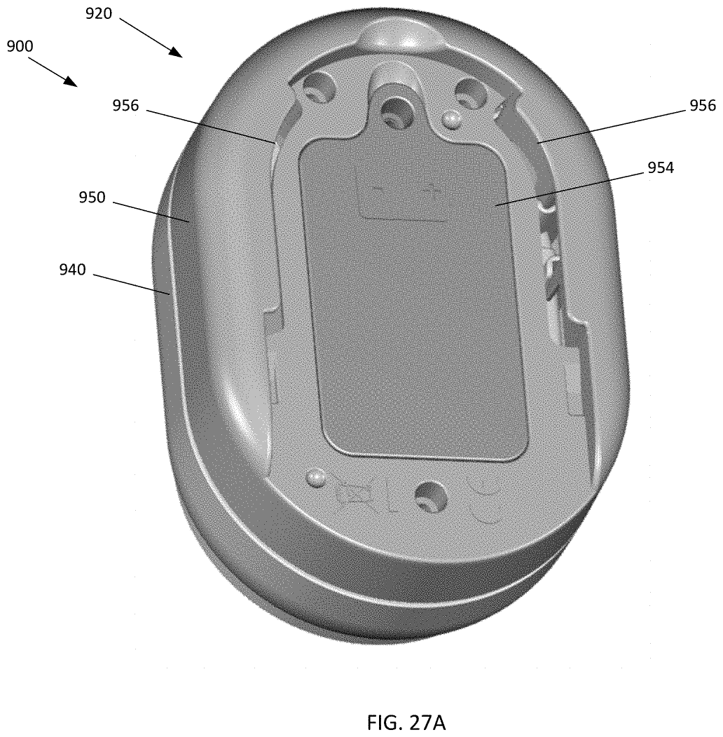

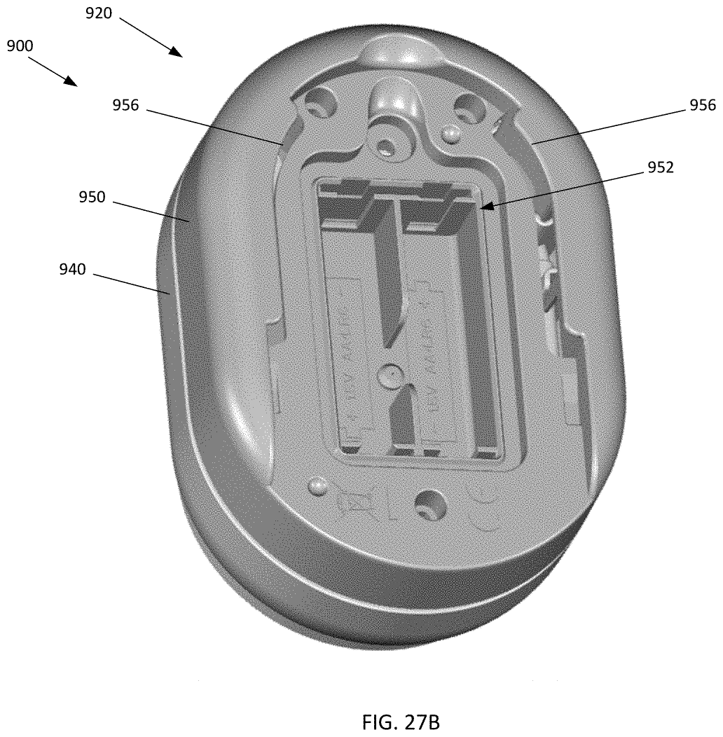

Turning to FIGS. 22B, 27A, and 27B, illustrated is the rear side 934 of the second housing portion 930 of the remote actuator 900. As previously explained, the second housing half 950 of the second housing portion 930 is disposed more proximate to the rear side 934 of the second housing portion 930 than the first housing half 940. As best illustrated in FIG. 27B, the second housing half 950 include a cavity 952 that is configured to receive one or more batteries that may be configured to power the remote actuator 900. The second housing half 950 may further include a cavity cover 954, as illustrated in FIG. 27A, which is configured to cover the cavity 952 and secure any batteries within the cavity 952. As further illustrated in FIGS. 27A and 27B, the second housing half 950 includes one or more slots 956 that are disposed around the cavity 952 and the cavity cover 954. As best illustrated in FIG. 22B, the slots are configured to receive the mount plate 936. The mount plate 936 may include one or more openings 938 that extend through the mount plate 936. An operator of the gate 10 may secure the mount plate 936 to a wall or other surface via screws or other fasteners that extend through the openings 938. Once the mount plate 936 is secured to a surface, the remote actuator 900 may be coupled to the mount plate 936 by sliding the second housing half 950 along the mount plate 936 such that the mount plate 936 slides into the slots 956. With the mount plate 936 secured to a surface and disposed within the slots 956 of the second housing half 950 of the second housing portion 930 of the remote actuator 900, the remote actuator 900 is removably mounted to the surface via the mount plate 936.

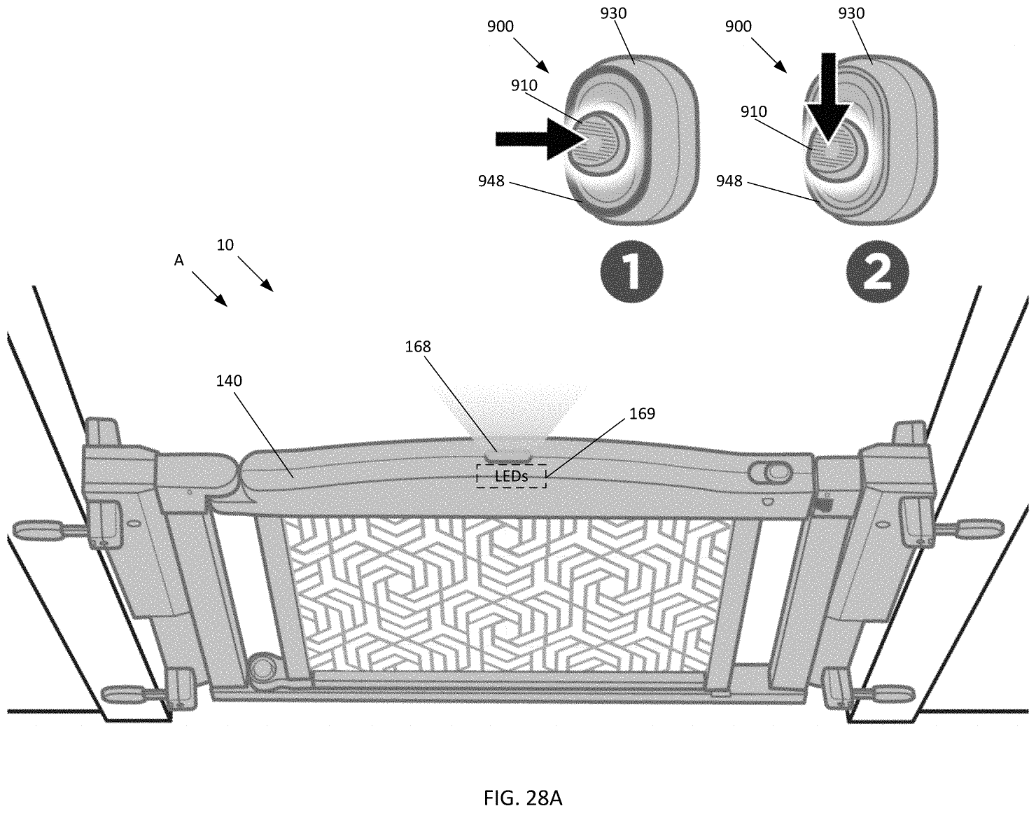

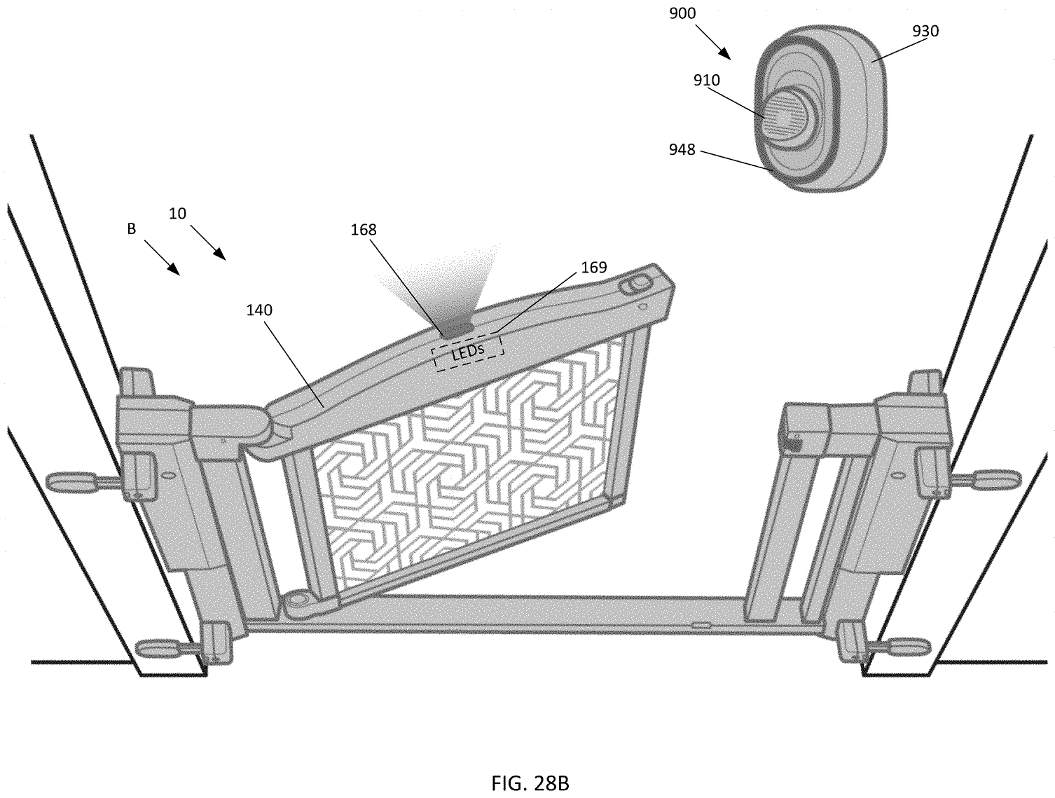

Turning to FIGS. 28A and 28B, and with continued reference to FIGS. 22A, 22B, 23A, 23B, 24, 25A, 25B, and 26, illustrated are operations of the second embodiment of the remote actuator 900 with the door 140 of the safety gate 10. As illustrated in FIG. 28A, in order to remotely unlock the door 140 so that the door 140 may be opened, the first housing portion 910 of the remote actuator 900 may be moved in a first direction (i.e., the push button 912 may be depressed) and then in a second direction (i.e., the first housing portion 910 slid downwardly) with respect to the second housing portion 930 of the remote actuator 900. As previously explained, the push button 912 of the first housing portion 910 of the remote actuator 900 may first be depressed along the axis/plane K. When the push button 912 is depressed along the axis/plane K, the first actuator switch 970 may be actuated, and the visual output device 980 may be configured to output a first visual output, which may be visible through the translucent ring 948. The first visual output may be of a certain color (e.g., red, green, blue, etc.), may be a certain series/sequence of colors, or may be a certain series/sequence of visual outputs (e.g., flashes, bursts, etc.).

After the push button 912 of the first housing portion 910 has been depressed, and while the push button 912 of the first housing portion 910 remains depressed, the first housing portion 910 may then be slid downwardly along axis/plane L with respect to the second housing portion 930. As previously explained, when slid downwardly along the axis/plane L, the second actuator switch 972 disposed within the remote actuator 900 may be actuated, and the visual output device 980 may be configured to output a second visual output, which may be visible through the translucent ring 948, and which may differ from the first visual output. Performing these movements of the first housing portion 910 with respect to the second housing portion 930 causes the latch mechanism 170 (not shown in FIGS. 28A and 28B) of the door 140 to translate to the stowed position (i.e., the motor 176, set of gears 178, and rack member 180 are moved to reposition the door latch 190 along axis E), as previously described, which enables the door 140 to be rotated to the opened position B (shown in FIG. 28B). In addition, performing these movements of the first housing portion 910 with respect to the second housing portion 930 causes the LEDs 169 of the door 140 to output a first visual output through the translucent portion 168 of the door 140. In some embodiments, the first visual output of the LEDs 169 of the door 140 may be similar or identical to the second visual output of the visual output device 980 of the remote actuator 900 (e.g., both may output a green color).

As illustrated in FIG. 28B, when the door 140 is rotated to the opened position B, the LEDs 169 of the door 140 may output a second visual output that differs from the first visual output of the LEDs 169 of the door 140. The second visual output of the LEDs 169 may be visible through the translucent portion 168 of the door 140. Simultaneous to the door 140 being rotated to the opened position B and the output of the second visual output of the LEDs 169 of the door 140, the visual output device 980 of the remote actuator 900 may be configured to output a third visual output that may be similar or identical to the second visual output of the LEDs 169 of the door 140. In some embodiments, the third visual output of the visual output device 980 of the remote actuator 900 may be similar or identical to the first visual output of the visual output device 980. In other embodiments, the third visual output of the visual output device 980 of the remote actuator 900 may differ from both the first and second visual outputs of the visual output device 980 of the remote actuator 900. Once the door 140 is returned to the closed position A, the visual output device 980 of the remote actuator 900 and the LEDs 169 of the door 140 may no longer output a visual output.

It is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Although the disclosed inventions are illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

What is claimed is:

1. A safety gate comprising:
a frame;
a door pivotally coupled to the frame, the door comprising a latch mechanism; and
a remote actuator in wireless communication with the latch mechanism, the remote actuator comprising:
a first housing portion; and
a second housing portion movably coupled to the first housing portion, the second housing portion being movable with respect to the first housing portion between at least a first position and a second position, wherein moving the second housing portion to the first position and then moving the second housing portion to the second position operates the latch mechanism.

2. The safety gate of claim 1, wherein the latch mechanism comprises:
a control assembly in wireless communication with the remote actuator;
a motor operatively connected to the control assembly;
and a latch operatively connected to the motor, wherein the latch is configured to translate between a deployed position, where the latch retains the door in a closed position, and a stowed position, where the door is free to pivot with respect to the frame from the closed position to an opened position.

3. The safety gate of claim 2, wherein moving the second housing portion to the first position and then moving the second housing portion to the second position causes the latch of the latch mechanism to reposition from the deployed position to the stowed position.

4. The safety gate of claim 3, wherein, after the latch has been repositioned to the stowed position for a predetermined period of time, repositioning the latch to the deployed position.

5. The safety gate of claim 4, further comprising:
an audible output device coupled to the frame, the door, or the remote actuator; and
a sensor coupled to the frame or the door, the sensor being configured to determine if the door is in the opened position or the closed position.

6. The safety gate of claim 5, wherein the predetermined period of time is a first predetermined period of time, and wherein the audible output device is configured to output an audible output if the door has remained in the opened position for a second predetermined period of time.

7. The safety gate of claim 4, further comprising:
a visual output device coupled to the frame, the door, or the remote actuator; and
a sensor coupled to the frame or the door, the sensor being configured to determine if the door is in the opened position or the closed position.

8. The safety gate of claim 7, wherein the predetermined period of time is a first predetermined period of time, and wherein the visual output device is configured to output a visual output if the door has remained in the opened position for a second predetermined period of time.

9. A remote actuator for a safety gate, the remote actuator comprising:
a first housing portion configured to be mounted on a wall; and
a second housing portion movably coupled to the first housing portion, the second housing portion being movable with respect to the first housing portion between at least a first position and a second position, wherein moving the second housing portion to the first position and then moving the second housing portion to the second position operates a latch mechanism of the safety gate.

10. The remote actuator of claim 9, further comprising:
a first actuator switch disposed within the first housing portion; and
a second actuator switch disposed within the first housing portion.

11. The remote actuator of claim 10, wherein, when the second housing portion is moved to the first position, the first actuator switch is actuated by the second housing portion.

12. The remote actuator of claim 11, wherein, when the second housing portion is moved to the first position, the second housing portion is depressed along an axis extending through the first housing portion and the second housing portion.

13. The remote actuator of claim 12, wherein, when the second housing portion is moved to the second position, the second actuator switch is actuated by the second housing portion.

14. The remote actuator of claim 13, wherein, when the second housing portion is moved to the second position, the second housing is slid in a first direction with respect to the first housing portion.

15. The remote actuator of claim 14, wherein, when the second housing is moved to the second position, the second housing portion is slid in the first direction while remaining depressed.

16. The remote actuator of claim 9, further comprising:
a visual output device.

17. A safety gate comprising:
a frame;
a door pivotally coupled to the frame, the door comprising a latch mechanism that is operable via a manual actuation and a remote actuation; and
a remote actuator in wireless communication with the latch mechanism, the remote actuator comprising:
a first housing portion; and
a second housing portion movably coupled to the first housing portion, the second housing portion being movable with respect to the first housing portion between a first position and a second position, wherein moving the second housing portion to the first position and then moving the second housing portion to the second position causes the latch mechanism to operate via the remote actuation.

18. The safety gate of claim 17, wherein the latch mechanism comprises:
a control assembly in wireless communication with the remote actuator;
a motor operatively connected to the control assembly;
a latch operatively connected to the motor wherein the latch is configured to translate between a deployed position, where the latch is configured to retain the door in a closed position, and a stowed position, where the door is free to pivot with respect to the frame from the closed position to an opened position; and
a spring operatively coupled to the latch.

19. The safety gate of claim 18, wherein, when the latch mechanism is operated via the manual actuation, the latch is manually pulled from the deployed position to the opened position, and is biased by the spring to the deployed position.

20. The safety gate of claim 19, wherein, when the latch mechanism is operated via the remote actuation, the motor translates the latch between the deployed position and the stowed position.
